(19) United States
(12) Patent Application Publication
(10) Pub. No.: US 2025/0226572 A1
(43) Pub. Date: Jul. 10, 2025

(54) ANTENNA STRUCTURE AND DEVICE COMPRISING SAME

(71) Applicant: Samsung Electronics Co., Ltd., Suwon-si (KR)

(72) Inventors: Sangha LEE, Suwon-si (KR); Seunghwan KIM, Suwon-si (KR); Jaebong CHUN, Suwon-si (KR); Un KIM, Suwon-si (KR); Jongsuk KIM, Suwon-si (KR); Yoonjung KIM, Suwon-si (KR); Taegyu KIM, Suwon-si (KR); Kyihyun JANG, Suwon-si (KR); Sanghoon CHOI, Suwon-si (KR)

(21) Appl. No.: 19/092,489

(22) Filed: Mar. 27, 2025

Related U.S. Application Data
(63) Continuation of application No. PCT/KR2023/014709, filed on Sep. 25, 2023.

(30) Foreign Application Priority Data
Sep. 30, 2022 (KR) 10-2022-0125820
Nov. 21, 2022 (KR) 10-2022-0156752

(51) Int. Cl. H01Q 1/27; H01Q 1/38

(52) U.S. Cl. CPC H01Q 1/27; H01Q 1/38

(57) ABSTRACT

A wearable device is provided. The wearable device includes a housing with a ring-shape including an inner surface and an outer surface, a first layer between the inner surface and the outer surface, including a printed circuit board (PCB), a second layer between the outer surface and the first layer, including a conductive portion, at least one circuit for wireless communication attached to the PCB, another conductive portion formed in a portion of the inner surface, a first coupling member for electrically connecting the conductive portion and the another conductive portion, and a second coupling member for electrically connecting the conductive portion and the at least one circuit, wherein the at least one circuit is configured to communicate with an external electronic device by using the conductive portion obtaining a signal fed from the at least one circuit and the another conductive portion coupled to a ground.

### CROSS-REFERENCE TO RELATED APPLICATION(S)

This application is a continuation application, claiming priority under 35 U.S.C. § 365 (c), of an International application No. PCT/KR2023/014709, filed on Sep. 25, 2023, which is based on and claims the benefit of a Korean patent application number 10-2022-0125820, filed on Sep. 30, 2022, in the Korean Intellectual Property Office, and of a Korean patent application number 10-2022-0156752, filed on Nov. 21, 2022, in the Korean Intellectual Property Office, the disclosure of each of which is incorporated by reference herein in its entirety.

### BACKGROUND

### 1. Field

The disclosure relates to an antenna structure and an electronic device including the same.

### 2. Description of Related Art

An electronic device may use an antenna to communicate with an external electronic device. For example, an electronic device (e.g., a wearable electronic device) worn by a user may have structural limitations (e.g., miniaturization) in consideration of the user's wearing. The wearable device may be worn on a part of the user's body. For example, the wearable device may be worn on a portion of a user's finger.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an antenna structure and an electronic device including the same.

Additional aspects will be set forth in part in the description which follows and, in part, will be apparent from the description, or may be learned by practice of the presented embodiments.

In accordance with an aspect of the disclosure, a wearable electronic device is provided. The wearable device includes a housing with a ring-shape, including an inner surface and an outer surface, a first layer disposed between the inner surface and the outer surface of the housing, including a printed circuit board (PCB), a second layer disposed between the outer surface and the first layer, including a conductive portion, at least one circuit for wireless communication attached to the PCB, another conductive portion formed in a portion of the inner surface, a first coupling member for electrically connecting the conductive portion and the another conductive portion, and a second coupling member for electrically connecting the conductive portion and the at least one circuit, wherein the at least one circuit is configured to communicate with an external electronic device by using the conductive portion obtaining a signal fed from the at least one circuit and the another conductive portion coupled to a ground.

In accordance with another aspect of the disclosure, a wearable device is provided. The wearable device includes a housing with a ring-shape, including an inner surface and an outer surface, a layer disposed between the inner surface and the outer surface of the housing, including a printed circuit board (PCB) and a conductive portion, at least one circuit for wireless communication attached to the PCB, another conductive portion formed in a portion of the inner surface, a first coupling member for electrically connecting the PCB and the another conductive portion, and a second coupling member for electrically connecting the conductive portion and the at least one circuit, wherein the at least one circuit configured to communicate with an external electronic device by using the conductive portion obtaining a signal fed from the at least one circuit and the another conductive portion coupled to a ground.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates an example of an electronic device worn by a user according to an embodiment of the disclosure;

FIGS. 3A and 3B are perspective views of various examples of an electronic device according to various embodiments of the disclosure;

FIG. 4 is a side perspective view of various examples of an electronic device according to an embodiment of the disclosure;

FIGS. 5A, 5B, and 5C illustrate examples of a connection state between components of an electronic device according to various embodiments of the disclosure;

FIGS. 6A and 6B are graphs illustrating examples of the performance of an electronic device when a user's body is used as a ground, according to various embodiments of the disclosure;

FIGS. 7A and 7B illustrate various examples of an electronic device according to an antenna structure according to various embodiments of the disclosure;

FIG. 8 illustrates various examples of an electronic device according to an antenna structure according to an embodiment of the disclosure;

FIG. 9 illustrates various examples of an outer surface of an electronic device according to an embodiment of the disclosure;

FIG. 10 illustrates various examples of a conductor on an inner surface of an electronic device according to an embodiment of the disclosure;

FIG. 11 illustrates various examples of an electronic device in a grounding method according to an embodiment of the disclosure;

FIG. 12 is a graph illustrating an example of a plurality of antenna radiators of an electronic device connected to the same ground and an example of the radiation performance of the antenna radiators, according to an embodiment of the disclosure;

FIG. 13 is a graph illustrating an example of a case in which a position to be grounded to an electronic device is changed and an example of the radiation performance of such an antenna radiator, according to an embodiment of the disclosure;

FIG. 14 is a graph illustrating an example of a case in which antenna radiators of an electronic device are formed in an edge area of the electronic device and an example of the radiation performance of the antenna radiator according to a state of the antenna radiator, according to an embodiment of the disclosure;

FIG. 15 is a graph illustrating examples of a ground part of an electronic device and an example of the radiation performance of the antenna radiator, according to an embodiment of the disclosure;

FIG. 16 illustrates an example of an outer surface of an electronic device used as an antenna radiator according to an embodiment of the disclosure;

FIG. 17 is a graph illustrating an example of an electronic device that emits signals by changing an antenna radiator according to an external environment, and an example of the radiation performance of the antenna radiator, according to an embodiment of the disclosure;

FIG. 18 is a graph illustrating examples of a position of a ground part of an electronic device and an example of the radiation performance of the antenna radiator, according to an embodiment of the disclosure;

FIG. 19A illustrates examples of electronic devices of various sizes according to an embodiment of the disclosure;

FIG. 19B illustrates examples of a tuning structure of a feeding part for electronic devices of various sizes according to an embodiment of the disclosure;

FIG. 19C illustrates examples of a tuning structure of a ground part for electronic devices of various sizes according to an embodiment of the disclosure; and

FIG. 20 illustrates an example of an electronic device including a display according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used herein, including technical and scientific terms, may have the same meanings as those commonly understood by those skilled in the art to which the disclosure pertains. Terms defined in a general dictionary among the terms used in the disclosure may be interpreted as having the same or similar meaning as those in the context of the related art, and they are not to be construed in an ideal or overly formal sense, unless explicitly defined in the disclosure. In some cases, even the terms defined in the disclosure may not be interpreted to exclude embodiments of the disclosure.

In various examples of the disclosure described below, a hardware approach will be described as an example. However, since various embodiments of the disclosure may include a technology that utilizes both the hardware-based approach and the software-based approach, the various embodiments are not intended to exclude the software-based approach.

As used in the following description, terms referring to a configuration of a device (e.g., processor, housing, display, battery, antenna radiator, printed circuit board (PCB) module, etc.), terms referring to operational states (e.g., step, operation, procedure), terms referring to some of components of a device (e.g., member, portion, inner surface, outer surface, layer, etc.), terms referring to a functional structure of a device (e.g., feeding part, ground part, connection part, etc.), terms referring to materials (e.g., electrical conductor, insulator, etc.), terms referring to connection between components of a device (e.g., a soldering, coupling, connector to connector (CTC), etc.), terms referring to connections between components of the device (e.g., a soldering, coupling, connector to connector, etc.), terms to refer to data (e.g., parameter, value, etc.) are exemplified for convenience of explanation. Therefore, the disclosure is not limited to the terms described below, and other terms having equivalent technical meanings may be used.

Further, throughout the disclosure, an expression, such as e.g., ‘above (more than)’ or ‘below (less than)’ may be used to determine whether a specific condition is satisfied or fulfilled, but it is merely a description for expressing an example and is not intended to exclude the meaning of ‘more than or equal to’ or ‘less than or equal to’. A condition described as ‘more than or equal to’ may be replaced with an expression, such as ‘more than’, a condition described as ‘less than or equal to’ may be replaced with an expression, such as ‘less than’, and a condition described as ‘more than or equal to and below’ may be replaced with ‘more than and less than or equal to’, respectively. Furthermore, hereinafter, ‘A’ to ‘B’ means at least one of the elements from A (inclusive of A) to B (inclusive of B).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

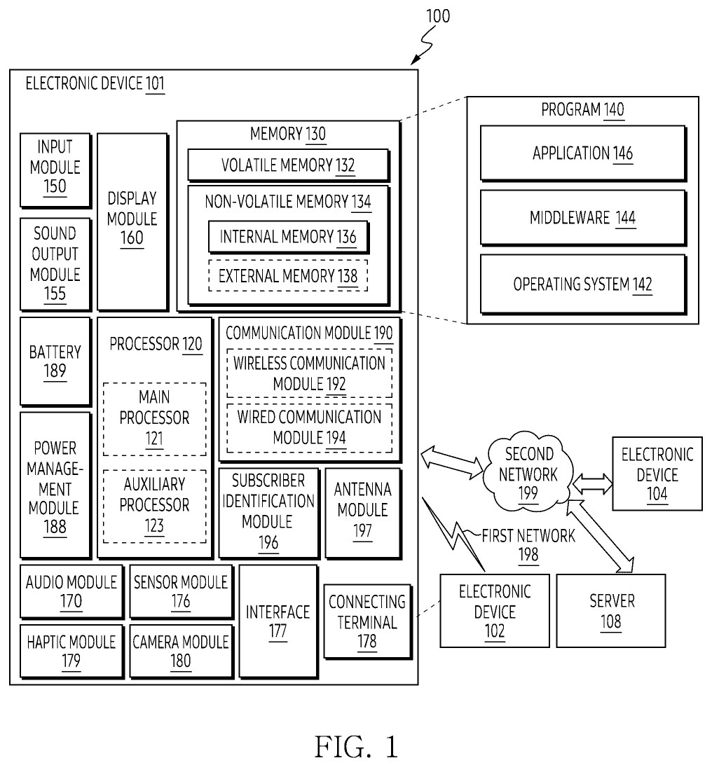

FIG. 1 is a block diagram of an electronic device in a network environment according to an embodiment of the disclosure.

FIG. 1 is a block diagram of an electronic device in a network environment 100 according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to address, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may be a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

As the technology advances, electronic devices are gradually becoming smaller and smaller. For example, electronic device that may be worn and used by a user are currently being developed. For example, a wearable electronic device may be an electronic device that may be worn on a part of the user's body, such as a finger, a wrist, a hand, and a body. The wearable device may have limited size or structure. For communication with external electronic devices, the wearable device may include an antenna for transmitting and receiving signals. However, for wearable devices that are limited in size or structure, the radiation performance of the antenna may be limited. Depending on the limitation of the radiation performance of the antenna, the wearable device may have difficulty in long-range communication. For short-range communication such as near field communication (NFC), a ring-shaped wearable device may be mounted with a coil-type antenna. A wearable device including such a coil-type antenna may be difficult to interwork or communicate with an external electronic device (e.g., a user equipment, an augmented reality (AR) device, or a virtual reality (VR) device) located at a long distance. Further, a glove-shaped wearable device may include a structure in which a ring is mounted inside a glove and the ring is connected via wire with a processor that controls the ring, for interworking or communication with other devices. Such a glove-shaped wearable device may communicate with an external electronic device located at a long distance via the ring connected by wire. However, for the glove-shaped wearable device, there may be structural limitations in connection via a wired line, and each of the rings inside the glove may not include a function to transmit and receive signals by itself.

Hereinafter, embodiments of the disclosure propose a technology for wirelessly connecting to other devices even in the case of a miniaturized electronic device (e.g., a ring-shaped wearable device). Specifically, the disclosure proposes a technology for improving the radiation performance of an antenna of a wearable device and securing the performance complying with users' requirements.

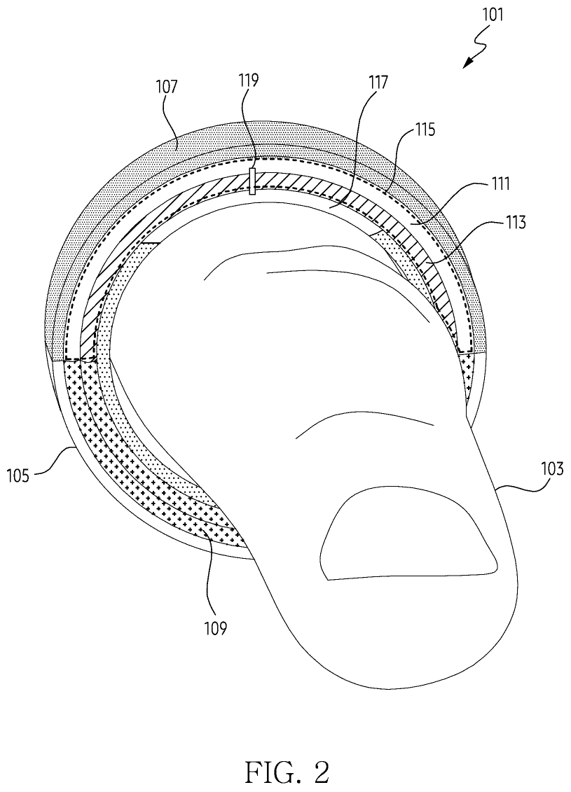

FIG. 2 illustrates an example of an electronic device worn by a user according to an embodiment of the disclosure. The user may refer to a person wearing the electronic device. The electronic device may be a wearable device that may be worn by a user. The electronic device 101 of FIG. 2 may be an example of the electronic device 101 of FIG. 1.

Referring to FIG. 2, the electronic device 101 may be formed in a ring shape. For example, a housing 105 of the electronic device 101 may be formed in a ring shape that may be worn on a user's finger 103. Although FIG. 2 illustrates a ring-shaped electronic device 101 having a smooth surface, the disclosure is not limited thereto. For example, the electronic device 101 may be implemented as a housing including a plurality of planes. For example, the ring-shaped electronic device 101 having a non-smooth surface may also be understood as an embodiment of the disclosure.

According to an embodiment, the electronic device 101 may include a housing 105, an antenna radiator 111, a printed circuit board (PCB) 113, an electrical conductor 117 in contact with a part of a user's body, or a coupling member 119 connecting the antenna radiator 111 with the conductor 117.

According to an embodiment, the ring-shaped housing 105 may include an outer surface exposed to an outside while being worn by the user, an inner surface in contact with the user's body part, and a side surface between the outer surface and the inner surface. A space 115 for accommodating components, such as e.g., the antenna radiator 111 and the PCB 113, and/or a space 109 for accommodating a battery may be included between the inner surface and the outer surface of the housing 105. For example, the housing 105 may include a plurality of layers between the inner surface and the outer surface, and components such as the antenna radiator 111, the PCB 113, or the battery may be located in an area corresponding to the layer(s). For example, components included in the electronic device 101 may be located in one layer or a plurality of layers, and may be connected through a structure for connection, such as a coupling member 119.

According to an embodiment, the outer surface of the housing 105 may include a display 107. However, the disclosure is not limited thereto, and the outer surface may be implemented only with a non-conductive member or a conductive member for the exterior appearance without such a display 107. In an embodiment, the inner surface of the housing 105 may include the conductor 117 that is a conductive portion. The user's body may be used as a ground with respect to the antenna radiator 111 of the electronic device 101. When the conductor 117 of the inner surface is located in an area close to the user's body (e.g., when the user wears the electronic device 101), the conductor 117 of the inner surface may be connected to the ground. For example, the inner surface of the housing 105 may include a conductive coating layer for one surface of the conductor 117 located close to the user's body. The conductor 117 does not come into direct contact with the user's body due to the conductive coating layer, but it may be located in an area close to the user's body, and the conductor 117 may be electromagnetically coupled to the ground. The conductive coating layer may be included in the inner surface area of the housing 105 corresponding to the one surface of the conductor 117. The conductive coating layer may be implemented as a non-conductive layer including a conductive portion. For example, through the non-conductive layer formed by the conductive coating layer, the conductor above 117 may be formed not to be directly connected to the user's body. The conductive coating layer may be formed to be electromagnetically coupled between the conductor above 117 and the user's body, based on the conductive portion of the conductive coating layer.

In an embodiment, at least a partial area of the conductor 117 may be used as a sensor. For example, the conductor 117 may be used as an electrode sensor for detecting a user's bio-signal. The electrode sensor for detecting the user's bio-signal may include, for example, an electrocardiogram (ECG) sensor, a temperature sensor, or a sensor for measuring pulse.

In an embodiment, an area in which the conductor 117 is included in the inner surface of the housing 105 may correspond to a partial or whole area in contact with the body of the user. For example, an area of the inner surface that does not include the conductor 117 may be implemented as a non-conductor (or a non-conductive member), or the entire inner surface may be implemented as a conductive member.

According to an embodiment, the antenna radiator 111 may include a conductive portion through which the electronic device 101 radiates signals to communicate with an external electronic device. For example, the antenna radiator 111 may include a conductive member of various structures (e.g., ring, slot, or U-ring) as a radiator. The antenna radiator 111 may be electrically connected to a wireless communication circuit (e.g., at least one processor) located in the space 115 or on the PCB 113. The antenna radiator 111 may be fed with signals from the wireless communication circuit. As the antenna radiator 111 radiates the fed signals, the electronic device 101 may communicate with an external electronic device. The antenna radiator 111 may be disposed on at least one of a plurality of layers of the housing 105. For example, the antenna radiator 111 may be mounted on the same layer as the PCB 113 or on a different layer. The antenna radiator 111 may be electrically connected to the PCB 113. For example, the antenna radiator 111 may be directly connected to the PCB 113 by means of a soldering or a connector. For example, the antenna radiator 111 may be electromagnetically coupled to the PCB 113 through coupling. The antenna radiator 111 may be electrically connected to the conductor 117, and accordingly, may be connected to the ground. The ground may be a body part (e.g., a finger) of the user.

According to an embodiment, a wireless communication circuit for performing communication with an external electronic device may be disposed on the PCB 113. For example, the wireless communication circuit may include at least one processor. The PCB 113 may be electrically connected to the antenna radiator 111, and thus the antenna radiator 111 may be fed with power from the wireless communication circuit of the PCB 113. The PCB 113 may be disposed on at least one of a plurality of layers of the housing 105. For example, the PCB 113 may be located on the same layer as the antenna radiator 111 or on a different layer.

According to an embodiment, the space 115 inside the housing 105 may include components including the antenna radiator 111 and the PCB 113. For example, the space 115 may include components such as a filter or a processor. In an embodiment, the space 115 may be formed to be separated from the space 109 for mounting a battery. However, the disclosure is not limited thereto, and the space 115 may be connected to the space 109 to be implemented as a single space, and accordingly, the battery may be disposed within the space 115. For example, the space 109 or the space 115 may refer to an area including at least one layer between the inner surface and the outer surface of the housing 105.

According to an embodiment, the conductor 117 may be formed in one area of the inner surface. For example, the inner surface of the housing 105 may include the conductor 117 in the inner surface. The conductor 117 may include, for example, a conductive member. When the user wears the electronic device 101, the conductor 117 is located in an area close to the user's body to be electromagnetically coupled to the user's body. For example, the conductor 117 may be electromagnetically coupled to the user's body through a conductive coating layer for coating the conductor 117. The conductive coating layer may be implemented as a non-conductive layer including a conductive portion. For example, the conductor 117 may be formed not to be directly connected to the user's body, owing to the non-conductive layer formed by the conductive coating layer. The conductive coating layer may be formed to be electromagnetically coupled between the conductor 117 and the user's body, based on the conductive portion of the conductive coating layer. The user's body may be used as a ground for the antenna radiator 111 of the electronic device 101. The conductor 117 may be electrically connected to the antenna radiator 111 via the coupling member 119. For example, the conductor 117 may be directly connected to the antenna radiator 111 through a coupling member 119. For example, the conductor 117 may be electrically connected to the antenna radiator 111 by passing through the PCB 113 through the coupling member 119. Therefore, the conductor 117 may connect between the antenna radiator 111 and the user's body serving as a ground of the antenna radiator 111. In an embodiment, an area in which the conductor 117 occupies the inner surface of the housing 105 may be changed. As the area in which the conductor 117 occupies the inner surface is changed, the radiation performance of the antenna radiator 111 may vary.

As described above, when the user wears the electronic device 101, the electronic device 101 (e.g., the wearable device) of the disclosure may include the conductive portion (e.g., the conductor 117) in contact with the user's body. Through the conductive portion in contact with the user's body, the conductive portion (e.g., the antenna radiator 111) for radiating signals may be connected to the ground. As the user's body is used as the ground, a ground area is enlarged, so that the electronic device 101 may improve the radiation performance of the antenna radiator 111. Further, since a structure for a separate ground may be omitted, the electronic device 101 may be implemented in a more miniaturized structure.

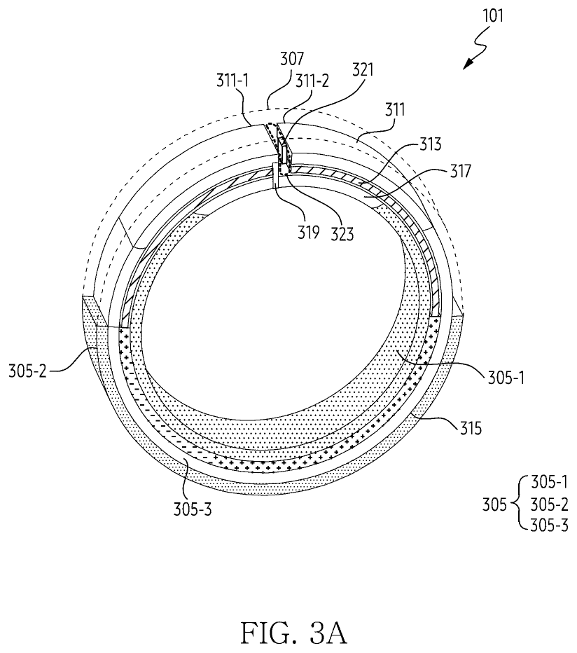

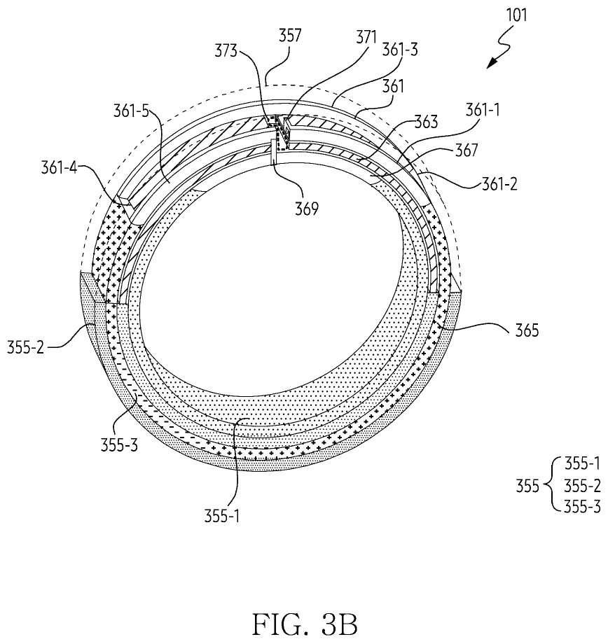

FIGS. 3A and 3B are perspective views of various examples of an electronic device according to various embodiments of the disclosure.

Each of the electronic device 101 of FIG. 3A and the electronic device 101 of FIG. 3B may be an example of the electronic device 101 of FIG. 1 and the electronic device 101 of FIG. 2.

Referring to FIGS. 3A and 3B, the electronic device 101 may be formed in a ring shape. For example, the housings 305 and 355 of the electronic device 101 may be formed in a ring shape that may be worn on a user's finger. In FIGS. 3A and 3B, the ring-shaped electronic device 101 having a smooth surface is illustrated as an example, but the disclosure is not limited thereto. For example, the electronic device 101 may be formed as a housing including a plurality of planes. For example, the ring-shaped electronic device 101 having a non-smooth surface may also be understood as an embodiment of the disclosure.

Referring to FIG. 3A, according to an embodiment, the electronic device 101 may include a housing 305, an antenna radiator 311, a printed circuit board 313 (PCB), an electrical conductor 317, a first coupling member 319 connecting the antenna radiator 311 to the conductor 317, and/or a second coupling member 321.

According to an embodiment, the ring-shaped housing 305 may include an outer surface 305-2 exposed to the outside while being worn by the user, an inner surface 305-1 in contact with the user's body, and a side surface 305-3 between the outer surface 305-2 and the inner surface 305-1. A space 315 for mounting the antenna radiator 311, the PCB 313 and the like may be included between the inner surface 305-1 and the outer surface 305-2. For example, the housing 305 may include a plurality of layers between the inner surface 305-1 and the outer surface 305-2, and components such as the antenna radiator 311, the PCB 313, or the battery may be disposed in an area corresponding to the layer(s). For example, the components included in the electronic device 101 may be arranged in divided areas in the space 315. The components included in the electronic device 101 may be disposed in one layer or a plurality of layers and may be connected through a structure for connection, such as the coupling member 319. The layer may represent a virtual area for distinguishing an area of the space 315. Accordingly, the electronic device 101 according to embodiments of the disclosure may include both the case where the components included in the electronic device 101 are arranged in a stacked state through a plurality of virtual layers in the space 315, or the case where the components are arranged by dividing the area in space 315 regardless of the layer.

According to an embodiment, the outer surface 305-2 of the housing 305 may include a display 307. However, the disclosure is not limited thereto, and the outer surface 305-2 may be formed only of a non-conductive member or a conductive member for the appearance without the display 307. In an embodiment, the inner surface 305-1 of the housing 305 may include the conductor 317 that is a conductive portion. The user's body may be used as a ground for the antenna radiator 311 of the electronic device 101. When the conductor 317 of the inner surface 305-1 is in contact with the user's body (for example, when the user wears the electronic device 101), the conductor 317 of the inner surface 305-1 may be connected to the ground. For example, the area including the conductor 317 in the inner surface 305-1 of the housing 305 may correspond to a partial or entire area in contact with the user's body. For example, the area of the inner surface 305-1 that does not include the conductor 317 may be implemented as a non-conductor (or a non-conductive member), or the entire inner surface 305-1 may be implemented as a conductive member.

According to an embodiment, the antenna radiator 311 may include a conductive portion through which the electronic device 101 radiates signals to communicate with an external electronic device. For example, the antenna radiator 311 may include a conductive portion of various structures (e.g., ring, slot, or U-ring). The antenna radiator 311 may be electrically connected to the wireless communication circuit (e.g., at least one processor) located in the space 315 or the PCB 313, through the second coupling member 321. The antenna radiator 311 may be fed with signals from the wireless communication circuit. The second coupling member 321 may be referred to, for example, as a feeding part. The electronic device 101 may communicate with an external electronic device, as the antenna radiator 311 radiates the fed signals. The antenna radiator 311 may be disposed on at least one of a plurality of layers of the housing 305. For example, the antenna radiator 311 may be mounted on the same layer as the PCB 313, or on a different layer. The antenna radiator 311 may be electrically connected to the PCB 313. For example, the antenna radiator 311 may be directly connected to the PCB 313 through a soldering or a connector. Further, the antenna radiator 311 may be electromagnetically connected to the PCB 313 through coupling. The antenna radiator 311 may be electrically connected to the conductor 317, and accordingly, may be connected to the ground. The ground may include the user's body (e.g., a finger).

According to an embodiment, the antenna radiator 311 may include a conductive member extending in a ring shape along the outer surface 305-2 from a portion connected to the second coupling member 321 (or the first coupling member 319), while being spaced apart from the conductor 317. For example, the antenna radiator 311 may include a surface-shaped conductive member disposed on a virtual surface corresponding to the outer surface 305-2. The virtual surface corresponding to the outer surface 305-2 may refer to a first layer. In an embodiment, the conductive member included in the antenna radiator 311 may be segmented. For example, the position of the segmented portion 323 may be changed depending upon the frequency band supported by the antenna radiator 311. The first conductive portion 311-1 of the antenna radiator 311 segmented from the first coupling member 319 and the second conductive portion 312-2 of the antenna radiator 311 extending from the second coupling member 321 may be spaced apart from each other. According to the above description, it is described the case where the antenna radiator 311 of the electronic device 101 extends from the second coupling member 321 and is segmented from the first coupling member 319, but the disclosure is not limited thereto. Regarding the same structure, it may be understood that the antenna radiator 311 extends from the first coupling member 319 and is segmented from the second coupling member 321. According to an embodiment, a wireless communication circuit for performing communication with an external electronic device may be disposed on the PCB 313. For example, the wireless communication circuit may include at least one processor. The PCB 313 may be electrically connected to the antenna radiator 311 through the second coupling member 321, and thus the antenna radiator 311 may receive signals from the wireless communication circuit of the PCB 313. The PCB 313 may be disposed on at least one of a plurality of layers of the housing 305. For example, the PCB 313 may be mounted on the same layer as the antenna radiator 311, or on a different layer. For example, the antenna radiator 311 may be disposed on a first layer between the outer surface 305-2 and the inner surface 305-1, and the PCB 313 may be disposed on a second layer between the first layer and the inner surface 305-1. For example, the antenna radiator 311 and the PCB 313 may be disposed on the same layer between the outer surface 305-2 and the inner surface 305-1.

According to an embodiment, the space 315 within the housing 305 may include components including the antenna radiator 311 and the PCB 313. For example, the space 315 may include components such as a filter or a processor. The space 315 may be formed to be separated from a space for accommodating a battery. However, the disclosure is not limited thereto, and the space 315 may be connected to the space for including the battery to be formed as one space, and thus, the battery may be disposed in the space 315. The space 315 may refer to an area including at least one layer between the inner surface 305-1 and the outer surface 305-2 of the housing 305.

According to an embodiment, the conductor 317 may be formed in one area of the inner surface 305-1. For example, the inner surface 305-1 of the housing 305 may include the conductor 317 in the inner surface 305-1. The conductor 317 may include, for example, a conductive member. When the user wears the electronic device 101, the conductor 317 may be electrically connected to the user's body. The user's body may be used as a ground for the antenna radiator 311 of the electronic device 101. The conductor 317 may be connected to the antenna radiator 311 through the first coupling member 319. For example, the conductor 317 may be electrically connected to the antenna radiator 311 through the first coupling member 319. For example, the conductor 317 may pass through the PCB 313 through the first coupling member 319 to be electrically connected to the antenna radiator 311. Accordingly, the conductor 317 may be electrically connected between the antenna radiator 311 and the user's body acting as a ground of the antenna radiator 311.

In an embodiment, an area in which the conductor 317 occupies the inner surface 305-1 of the housing 305 may be changed. As the area in which the conductor 317 occupies the inner surface 305-1 is changed, the radiation performance of the antenna radiator 311 may vary.

Referring to FIG. 3A, although it is illustrated that the first coupling member 319 is located in the first conductive portion 311-1 of the antenna radiator 311 adjacent to the segmented portion 323, embodiments of the disclosure are not limited thereto. The position of the first coupling member 319 may be changed according to the frequency band supported by the antenna radiator 311 or the structure of the electronic device 101. For example, the first coupling member 319 may be located in one area of the second conductive portion 311-2 which is the same as the second coupling member 321.

Referring to FIG. 3B, according to an embodiment, the electronic device 101 may include a housing 355, an antenna radiator 361, a printed circuit board 363 (PCB), an electrical conductor 367, a first coupling member 369 connecting the antenna radiator 361 and the electrical conductor 367, and/or a second coupling member 371.

According to an embodiment, the ring-shaped housing 355 may include an outer surface 355-2 exposed to the outside while being worn by the user, an inner surface 355-1 in contact with the user's body, and a side surface 355-3 between the outer surface 355-2 and the inner surface 355-1. A space 365 for including components such as the antenna radiator 361 and the PCB 363 may be included in between the inner surface 355-1 and the outer surface 355-2 of the housing 355. For example, the housing 355 may include a plurality of layers between the inner surface 355-1 and the outer surface 355-2, and components such as the antenna radiator 361, the PCB 363, or the battery may be disposed in an area corresponding to a layer or layers. The components included in the electronic device 101 may be disposed by dividing an area within the space 365. The components included in the electronic device 101 may be disposed in one layer or a plurality of layers, and may be connected via a structure for connection, such as the coupling member 369. The layer may represent a virtual area for dividing the area of the space 365. Accordingly, the electronic device 101 according to embodiments of the disclosure may include both the cases where the components included in electronic device 101 are disposed and stacked through a plurality of virtual layers in space 365, or disposed by dividing the area in the space 365 regardless of the layers.

According to an embodiment of the disclosure, the outer surface 355-2 of the housing 355 may include a display 357. However, the disclosure is not limited thereto, and the outer surface 355-2 may be formed only of a non-conductive member or a conductive member for the appearance without the display 357. In an embodiment, the inner surface 355-1 of the housing 355 may include the conductor 367 that is a conductive portion. The user's body may be used as a ground for the antenna radiator 361 of the electronic device 101. When the conductor 367 of the inner surface 355-1 is in contact with the user's body (for example, when the user wears the electronic device 101), the conductor 367 of the inner surface 355-1 may be connected to the ground. The area including the conductor 367 inside the inner surface 355-1 of the housing 355 may correspond to a partial or entire area that is in contact with the user's body. For example, the area of the inner surface 355-1 that does not include the conductor 367 may be implemented as a non-conductor (or a non-conductive member), or the entire inner surface 355-1 may be formed of a conductive member.

According to an embodiment, the antenna radiator 361 may include a conductive portion through which the electronic device 101 radiates a signal to communicate with an external electronic device. For example, the antenna radiator 361 may be formed as a conductive portion of various structures (e.g., ring, slot, U-ring, etc.). The antenna radiator 361 may be electrically connected to the wireless communication circuit (e.g., at least one processor) disposed in the space 365 or the PCB 363 through the second coupling member 371. The antenna radiator 361 may be fed with a signal from the wireless communication circuit. The second coupling member 371 may be referred to as a feeding part. The electronic device 101 may communicate with an external electronic device by radiating the fed signal from the antenna radiator 361. The antenna radiator 361 may be disposed on at least one of a plurality of layers of the housing 355. For example, the antenna radiator 361 may be mounted on the same layer as the PCB 363, or on a different layer. The antenna radiator 361 may be electrically connected to the PCB 363. For example, the antenna radiator 361 may be directly connected to the PCB 363 through a soldering or a connector. Further, the antenna radiator 361 may be electromagnetically connected to the PCB 363 through coupling. The antenna radiator 361 may be electrically connected to the conductor 367, and accordingly, may be connected to the ground. The ground may include a body (e.g., a finger) of a user.

According to an embodiment, the antenna radiator 361 may include conductive members extending along the outer surface 355-2, while being spaced apart from the conductor 367. For example, the antenna radiator 361 may include a first edge 361-1 extending in a clockwise direction (hereinafter, in a first direction) along the outer surface 355-1 at a portion connected to the second coupling member 371, a second edge 361-2 extending at the first edge 361-1 in a direction perpendicular to the first direction, and a third edge 361-3 extending at the second edge 361-2 in a counterclockwise direction (hereinafter, in a second direction), a fourth edge 361-4 extending at the third edge 361-3 in a direction perpendicular to the second direction, and a fifth edge 361-5 extending at the fourth edge 361-4 in the first direction to be connected to the first coupling member 369. Referring to FIG. 3B, the antenna radiator 361 may include the edges 361-1 to 361-5, which are belt-shaped conductive members. Unlike a surface-shaped antenna radiator 311 of FIG. 3A, the electronic device 101 of FIG. 3B may include the antenna radiator 361 including an opening (or slit) in the surface-shaped antenna radiator 311.

In this case, the first edge 361-1 and the fifth edge 361-5 may be spaced apart from the third edge 361-3. For example, when the first edge 361-1 and the fifth edge 361-5 are disposed in a first area that is one end of the virtual surface corresponding to the outer surface 355-2, the third edge 361-3 may be disposed in a second area that is an end opposite to the first area of the virtual surface corresponding to the outer surface 355-2. For example, the virtual surface corresponding to the outer surface 355-2 may refer to the first layer. For example, the antenna radiator 361 may include a conductive member forming a plurality of edges 361-1 to 361-5 disposed on the virtual surface corresponding to the outer surface 355-2. For example, the conductive member included in the antenna radiator 361 may be segmented. For example, the antenna radiator 361 may include a segmented portion 373. For example, the segmented portion 373 may be located between the first edge 361-1 of the antenna radiator 361 extended from the second coupling member 371 and the fifth edge 361-5 segmented from the first coupling member 369. A conductive portion (e.g., the first edge 361-1) of the antenna radiator 361 segmented from the first coupling member 369 and a conductive portion (e.g., the fifth edge 361-5) of the antenna radiator 361 extended from the second coupling member 371 may be spaced apart from each other. According to the above description, it is described the case where the antenna radiator 361 of the electronic device 101 extends from the second coupling member 371 and is segmented at the first coupling member 369, but the disclosure is not limited thereto. Regarding the same structure, the antenna radiator 361 may be as extending from the first coupling member 369 and being segmented at the second coupling member 371.

According to an embodiment, a wireless communication circuit for performing communication with an external electronic device may be disposed on the PCB 363. For example, the wireless communication circuit may include at least one processor. The PCB 363 may be electrically connected to the antenna radiator 361 through the second coupling member 371, and thus the antenna radiator 361 may be fed with signals from the wireless communication circuit of the PCB 363. The PCB 363 may be disposed on at least one of a plurality of layers of the housing 355. For example, the PCB 363 may be disposed on the same layer as the antenna radiator 361, or on a different layer. For example, the antenna radiator 361 may be disposed on the first layer between the outer surface 355-2 and the inner surface 355-1, and the PCB 363 may be disposed on the second layer between the first layer and the inner surface 355-1. Alternatively, the antenna radiator 361 and the PCB 363 may be disposed on the same layer between the outer surface 355-2 and the inner surface 355-1.

According to an embodiment, the space 365 inside the housing 355 may include components including the antenna radiator 361 and the PCB 363. For example, the space 365 may include components such as a filter or a processor. According to an embodiment, the space 365 may be formed to be distinct from the space for including a battery. However, the disclosure is not limited thereto, and the space 365 may be connected to the space for including a battery to be implemented as a single space, and thus the battery may be disposed in the space 365. The space 365 may refer to an area including at least one layer between the inner surface 355-1 and the outer surface 355-2 of the housing 355.

According to an embodiment, the conductor 367 may be formed in one area of the inner surface 355-1. For example, the inner surface 355-1 of the housing 355 may include the conductor 367 in the inner surface 355-1. For example, the conductor 367 may include a conductive member. When the user wears the electronic device 101, the conductor 367 may be located in an area close to the user's body and may be electromagnetically coupled. For example, the inner surface 355-1 of the housing 355 may include a conductive coating layer for coating for one surface of the conductor 367 positioned close to the user's body. The conductive coating layer may be implemented as a non-conductive layer including a conductive portion. For example, the conductor 367 may be formed not to be directly connected to the user's body, through the non-conductive layer formed by the conductive coating layer. The conductive coating layer may be formed to be electromagnetically coupled between the conductor 367 and the user's body, based on the conductive portion of the conductive coating layer. Accordingly, the conductor 367 is not in direct contact with the user's body due to the conductive coating layer, but may be located in an area close to the user's body, and the conductor 367 may be connected to the ground. The conductive coating layer may be included in the area of the inner surface 355-1 of the housing 355 corresponding to the one surface of the conductor 367. The user's body may be used as a ground for the antenna radiator 361 of the electronic device 101.

In an embodiment, at least a partial area of the conductor 367 may be used as a sensor. For example, the conductor 367 may be used as an electrode sensor for detecting a user's bio-signal. The electrode sensor for detecting the bio-signal may include a sensor such as an electrocardiogram (ECG) sensor, a temperature sensor, or a sensor for measuring pulse.

According to an embodiment, the conductor 367 may be connected to the antenna radiator 361 through a first coupling member 369. For example, the conductor 367 may be directly electrically connected to the antenna radiator 361 through the first coupling member 369. For example, the conductor 367 may pass through the PCB 363, through the first coupling member 369, to be connected to the antenna radiator 361. Therefore, the conductor 367 may electrically connect between the antenna radiator 361 and the user's body acting as a ground for the antenna radiator 361. According to an embodiment, the first coupling member 369 may be connected to the PCB 363, but may not be connected to the conductor 367. For example, the first coupling member 369 may connect the antenna radiator 361 and the PCB 363, but may not be connected to the conductor 367. As the conductor 367 may be connected to the PCB 363, even though the conductor 367 is not directly connected to the antenna radiator 361 through the first coupling member 369, the conductor 367 may be electromagnetically connected to the antenna radiator 361. The structure and connection relation of the first coupling member 369 of FIG. 3B are merely of an example, and embodiments of the disclosure are not limited thereto.

In an embodiment, the area in which the conductor 367 is disposed on the inner surface 355-1 of the housing 355 may be changed. As the area in which the conductor 367 is disposed on the inner surface 355-1 is changed, the radiation performance of the antenna radiator 361 may vary.

Referring to FIG. 3B, although it is illustrated that the first coupling member 369 is positioned at the fifth edge 361-5 of the antenna radiator 311 adjacent to the segmented portion 373, embodiments of the disclosure are not limited thereto. The position of the first coupling member 369 may be changed according to the frequency band supported by the antenna radiator 361 or the structure of the electronic device 101. For example, the first coupling member 369 may be positioned at one area of the first edge 361-1 which is the same as the second coupling member 371.

Referring to FIGS. 3A and 3B, the electronic device 101 (e.g., a wearable device) of the disclosure may include a conductive portion (e.g., conductors 317 and 367) that is electromagnetically connected to the user's body, when the user wears the electronic device 101. The conductive portion (e.g., antenna radiators 311 and 361) for emitting signals may be connected to the ground, through the conductive portion that is electromagnetically connected to the user's body. As the user's body is used as the ground, the radiation performance of the antenna radiators 311 and 361 included in the electronic device 101 may be improved. In addition, as a structure for a separate ground may be omitted, the electronic device 101 may be implemented in a more miniaturized structure.

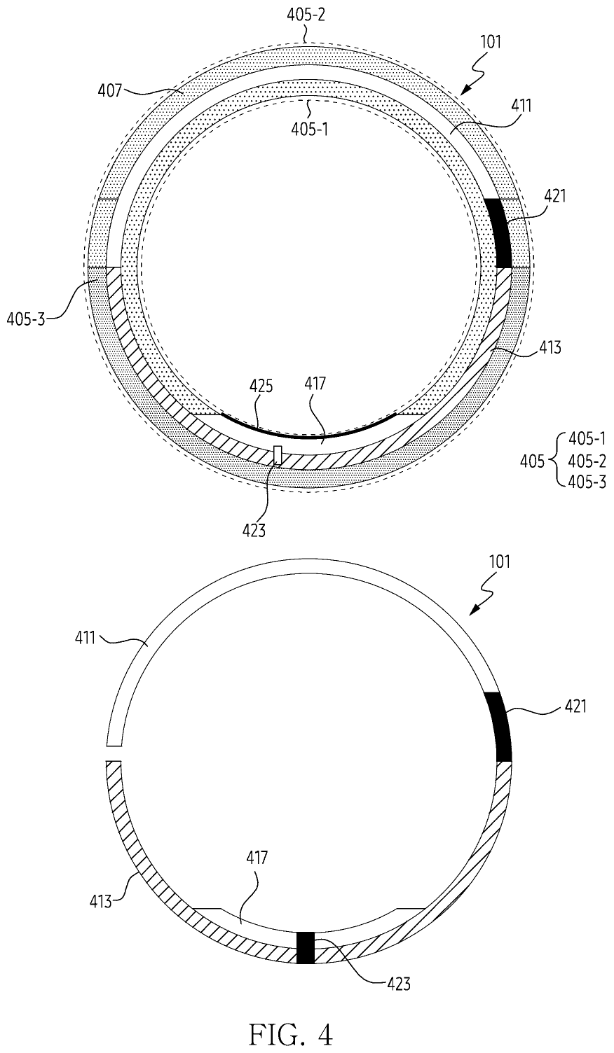

FIG. 4 is a side perspective view of various examples of an electronic device according to an embodiment of the disclosure. The electronic device 101 of FIG. 4 may be an example of the electronic device 101 of FIG. 1 and the electronic device 101 of FIG. 2.

Referring to FIG. 4, the electronic device 101 may be formed in a ring shape. For example, the housing 405 of the electronic device 101 may be formed in a ring shape that may be worn on a user's finger. Although FIG. 4 illustrates the ring-shaped electronic device 101 having a smooth surface, the disclosure is not limited thereto. For example, the electronic device 101 may be formed as a housing including a plurality of planes. For example, the ring-shaped electronic device 101 having a non-smooth surface may be understood as an embodiment of the disclosure.

Referring to FIG. 4, according to an embodiment, the electronic device 101 may include a housing 405 (e.g., the housing 305 of FIG. 3A, the housing 355 of FIG. 3B), an antenna radiator 411 (e.g., the antenna radiator 311 of FIG. 3A, the antenna radiator 361 of FIG. 3B), a printed circuit board (PCB) 413 (e.g., the PCB 313 of FIG. 3A, the PCB 363 of FIG. 3B), an electrical conductor 417 (e.g., the conductor 317 of FIG. 3A, the conductor 367 of FIG. 3B), a third coupling member 423 connecting the PCB 413 and the conductor 417, and a fourth coupling member 421 connecting the PCB 413 and the antenna radiator 411.

According to an embodiment, the ring-shaped housing 405 may include an outer surface 405-2 that is exposed to the outside while being worn by the user, an inner surface 405-1 that is in contact with the user's body, and a side surface 405-3 between the outer surface 405-2 and the inner surface 405-1. A space for including components such as the antenna radiator 411 and the PCB 413 may be included between the inner surface 405-1 and the outer surface of the housing 405. For example, the housing 405 may include a plurality of layers between the inner surface and the outer surface, and components such as the antenna radiator 411, the PCB 413, or the battery may be disposed in an area corresponding to a layer or layers. The components included in the electronic device 101 may be disposed in one layer or a plurality of layers and may be connected through a structure for connection, such as a coupling member.

According to an embodiment, the outer surface 405-2 of the housing 405 may include a display 407. However, the disclosure is not limited thereto, and the outer surface 405-2 may be formed only of a non-conductive member or a conductive member for the appearance without the display 407. In an embodiment, the inner surface 405-1 of the housing 405 may include the conductor 417 that is a conductive portion. The user's body may be used as a ground for the antenna radiator 411 of the electronic device 101. When the conductor 417 of the inner surface 405-1 is located in an area close to the user's body (for example, when the user wears the electronic device 101), the conductor 417 of the inner surface 405-1 may be connected to the ground. For example, the inner surface 405-1 of the housing 405 may include a conductive coating layer 425 for one surface of the conductor 417 located close to the user's body. The conductive coating layer 425 may be implemented as a non-conductive layer including a conductive portion. For example, through the non-conductive layer formed by the conductive coating layer 425, the conductor 117 may be formed not to be directly connected to the user's body. The conductive coating layer 425 may be formed to be electromagnetically coupled between the conductor 117 and the user's body, based on the conductive portion of the conductive coating layer 425. The conductor 417 is not in direct contact with the user's body by the conductive coating layer 425, but may be located in an area close to the user's body, and the conductor 417 may be electromagnetically coupled to the ground. The conductive coating layer 425 may be included in an area of the inner surface 405-1 of the housing 405 corresponding to the one surface of the conductor 417.

In an embodiment, at least a portion of the area of the conductor 417 may be used as a sensor. For example, the conductor 417 may be used as an electrode sensor for detecting a user's bio-signal. The electrode sensor for detecting the bio-signal may include an electrocardiogram (ECG) sensor, a temperature sensor, or a sensor for measuring pulse.

In an embodiment, an area including the conductor 417 in the inner surface 405-1 of the housing 405 may correspond to a partial or entire area in contact with the body of the user. For example, an area of the inner surface 405-1 that does not include the conductor 417 may include a non-conductor (or a non-conductive member), or the entire inner surface 405-1 may be formed of a conductive member.

According to an embodiment, the antenna radiator 411 may include a conductive portion through which the electronic device 101 radiates signals to communicate with an external electronic device. For example, the antenna radiator 411 may include a conductive portion of various structures (e.g., ring, slot, U-ring, etc.). The antenna radiator 411 may be electrically connected to a wireless communication circuit (e.g., at least one processor) disposed in a space between the outer surface 405-2 and the inner surface 405-1 of the housing 405 or PCB 413, through a fourth coupling member 421. The antenna radiator 411 may be fed with signals from the wireless communication circuit. The fourth coupling member 421 may be referred to as a feeding part. The electronic device 101 may communicate with the external electronic device by radiating the signal fed by the antenna radiator 411. In an embodiment, the antenna radiator 411 may be disposed on at least one of a plurality of layers of the housing 405. Unlike the electronic device 101 of FIGS. 3A and 3B, the antenna radiator 411 may be disposed on the same layer as the PCB 413. The antenna radiator 411 may be electrically connected to the PCB 413 via the fourth coupling member 421. For example, the antenna radiator 411 may be electrically connected to the PCB 413 using a soldering or a connector. For example, through the PCB 413, the antenna radiator 411 may be electrically connected to the conductor 417, and thus may be electrically connected to the ground. The ground may include a user's body (e.g., a finger).

According to an embodiment, the antenna radiator 411 may include a conductive member extending in a ring shape (e.g., a half-ring) along the outer surface 405-2 from a portion connected to the fourth coupling member 421, while being spaced apart from the conductor 417. For example, the antenna radiator 411 may include a surface-shaped conductive member disposed on a virtual surface corresponding to the outer surface 405-2. The virtual surface corresponding to the outer surface 405-2 may refer to a layer. The conductive member included in the antenna radiator 411 may be spaced apart from the PCB 413. For example, the antenna radiator 411 connected to the fourth coupling member 421 may be disposed to be spaced apart from the PCB 413.

According to an embodiment, the wireless communication circuit for performing communication with an external electronic device may be disposed on the PCB 413. For example, the wireless communication circuit may include at least one processor. The PCB 413 may be electrically connected to the antenna radiator 411 through the fourth coupling member 421, and thus the antenna radiator 411 may be fed with signals from the wireless communication circuit of the PCB 413. In an embodiment, the PCB 413 may be disposed on at least one of a plurality of layers of the housing 405. Unlike the electronic device 101 of FIGS. 3A and 3B, the PCB 413 of FIG. 4 may be mounted on the same layer as the antenna radiator 411. For example, the antenna radiator 411 and the PCB 413 may be disposed to be electrically connected through the fourth coupling member 421 on the same layer.

According to an embodiment, the space inside the housing 405 may include components including the antenna radiator 411 and the PCB 413. For example, the space may include components such as a filter, a processor, or a battery. The space may refer to an area including at least one layer between the inner surface 405-1 and the outer surface 405-2 of the housing 405.

According to an embodiment, the conductor 417 may be formed in one area of the inner surface 405-1. For example, the inner surface 405-1 of the housing 405 may include the conductor 417. The conductor 417 may include, for example, a conductive member. When the user wears the electronic device 101, the conductor 417 may be electrically connected to the user's body. The user's body may be used as a ground for the antenna radiator 411 of the electronic device 101. The conductor 417 may be electrically connected to the PCB 413 through the third coupling member 423. For example, the third coupling member 423 may electrically connect the conductor 417 and the PCB 413 through a soldering or hook structure.

According to an embodiment, the conductor 417 connected to the PCB 413 through the third coupling member 423 may be electrically connected to the antenna radiator 411 through the PCB 413 and the fourth coupling member 421. For example, the fourth coupling member 421 may electrically connect the antenna radiator 411 and the PCB 413 using a soldering or a connector structure (e.g., a connector to connector, CTC). Accordingly, the conductor 417 may electrically connect the user's body and the antenna radiator 411 through the third coupling member 423, the PCB 413, and the fourth coupling member 421. The user's body may be used as the ground for the antenna radiator 411.

According to an embodiment, an area in which the conductor 417 is disposed on the inner surface 405-1 of the housing 405 may be changed. For example, as the an area in which the conductor 417 is disposed on the inner surface 405-1 is changed, the radiation performance of the antenna radiator 411 may vary.

As described above, the electronic device 101 of FIG. 4 includes and a PCB and a conductive portion (e.g., an antenna) for radiation in one layer within the housing, unlike the electronic device 101 of FIGS. 3A and 3B, and thus it may be formed in a more miniaturized structure. Accordingly, the structure of the electronic device 101 may be simplified. However, as the mounting space inside the electronic device 101 is reduced, the space for arranging the PCB or the antenna may be reduced, or the structure of the antenna and the PCB that may be arranged therein may be limited.

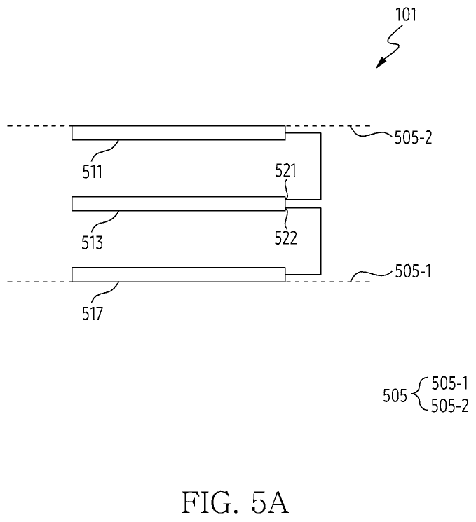

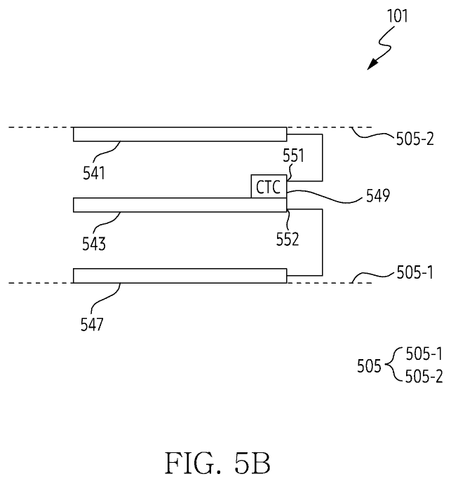

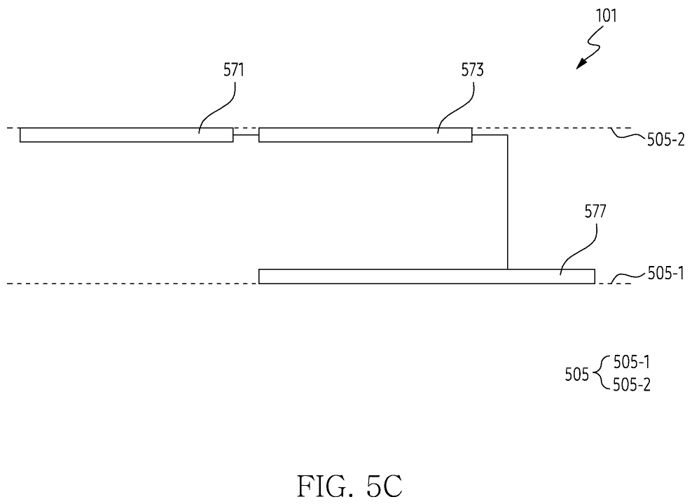

FIGS. 5A, 5B and 5C illustrate an example of a connection state between components of an electronic device according to various embodiments of the disclosure. The connection state of the electronic device 101 of FIGS. 5A to 5C may be understood as an example of the connection state of the electronic device 101 of FIG. 1. The connection state of the electronic device 101 of FIGS. 5A and 5B may be understood as an example of the connection state of the electronic device 101 of FIGS. 3A and 3B. The connection state of the electronic device 101 of FIG. 5C may be understood as an example of the connection state of the electronic device 101 of FIG. 4.

Referring to FIG. 5A, the electronic device 101 may include an antenna radiator 511 (e.g., the antenna radiator 311 of FIG. 3A, the antenna radiator 361 of FIG. 3B), a PCB 513 (e.g., the PCB 313 of FIG. 3A, the PCB 363 of FIG. 3B), and an electrical conductor 517 (e.g., the conductor 317 of FIG. 3A and the conductor 367 of FIG. 3B). The antenna radiator 511, the PCB 513, and the conductor 517 included in the electronic device 101 may be included in a housing 505 (e.g., the housing 305 of FIG. 3A, the housing 355 of FIG. 3B) of the electronic device. For example, the housing 505 may be formed in a ring shape. However, FIG. 5A illustrates a planar state in which the ring-shaped housing 505 is enlarged, for convenience of description. In an embodiment, the antenna radiator 511 and the PCB 513 may be disposed on different layers. For example, the antenna radiator 511 may be disposed on a first layer between the outer surface 505-2 and the inner surface 505-1 of the housing 505, and the PCB 513 may be disposed on a second layer between the first layer and the inner surface 505-1. For example, the first layer or the second layer may represent a virtual area for dividing a space between the outer surface 505-2 and the inner surface 505-1 of the housing 505. According to an embodiment, the antenna radiator 511 may be electrically connected to the PCB 513 in order to be fed with signals for radiation. For example, the antenna radiator 511 may be connected to the PCB 513 through a coupling member (e.g., the second coupling member 321 of FIG. 3A). For example, the coupling member may include a structure for a soldering or a coupling connection. In an embodiment, the conductor 517 may be electrically connected to the PCB 513 through a soldering. This may be to electrically connect the conductor 517 coupled to a part of the body acting as a ground and the antenna radiator 511, when the user wears the electronic device. Although FIG. 5A illustrates that the conductor 517 is connected to the antenna radiator 511 through the antenna radiator PCB 513, the disclosure is not limited thereto. The conductor 517 may be directly connected to the antenna radiator 511. Although FIG. 5A illustrates that the conductor 517, the PCB 513, and the antenna radiator 511 are connected in stages for convenience of description, a position of a part (e.g., the first portion 521) where the antenna radiator 511 and the PCB 513 are connected may be different from a position (e.g., the second portion 522) of a part where the antenna radiator 511 and the conductor 517 are connected. For example, a connection structure for connecting the antenna radiator 511 and the PCB 513 may be disposed in the first portion 521, and a connection structure for connecting the antenna radiator 511 and the conductor 517 (or the antenna radiator 511, the PCB 513, and the conductor 517) may be disposed in the second portion 522. As described above, the conductor 517 and the antenna radiator 511 or the PCB 513 and the antenna radiator 511 may be electrically connected.

Referring to FIG. 5B, the electronic devices 101 may include an antenna radiator 541 (e.g., the antenna radiator 311 of FIG. 3A, the antenna radiator 361 of FIG. 3B)), a PCB 543 (e.g., the PCB 313 of FIG. 3A, the PCB 363 of FIG. 3B), and an electrical conductor 547 (e.g., the conductor 317 of FIG. 3A and the conductor 367 of FIG. 3B). The antenna radiator 541, the PCB 543, and the conductor 547 included in the electronic device 101 may be included in a housing 505 (e.g., the housing 305 of FIG. 3A, the housing 355 of FIG. 3B). For example, the housing 505 may be formed in a ring shape. FIG. 5B illustrates a planar state in which a ring-shaped housing 505 is enlarged, for convenience of explanation. In an embodiment, the antenna radiator 541 and the PCB 543 may be disposed on different layers. For example, the antenna radiator 541 may be disposed on a first layer between the outer surface 505-2 and the inner surface 505-1 of the housing 505, and the PCB 543 may be disposed on a second layer between the first layer and the inner surface 505-1. According to an embodiment, the antenna radiator 541 may be electrically connected to the PCB 543 in order to be fed with signals for radiation. For example, the antenna radiator 541 may be connected to the PCB 543 through a coupling member. For example, the coupling member may include a structure for connection through a soldering, a coupling, or a connector. For example, a connector 549 may be disposed on one surface of the PCB 543. The antenna radiator 541 and the PCB 543 may be electrically (connector to connector, CTC) connected to each other through the connector 549. For example, the conductor 547 may be connected to the PCB 543 through a soldering. This may be to electrically connect the conductor 547 and the antenna radiator 541 coupled to a part of the body acting as a ground, when the user wears the electronic device 101. Although FIG. 5B illustrates that the conductor 547 is connected to the antenna radiator 541 through the antenna radiator PCB 543, the disclosure is not limited thereto. The conductor 547 may be directly connected to the antenna radiator 541. FIG. 5B illustrates that the conductor 547, the PCB 543, and the antenna radiator 541 are connected by stages for convenience of description, but a position of a part (e.g., the first portion 551) where the antenna radiator 541 and the PCB 543 are connected may be different from a position of a part (e.g., the second portion 552) where the antenna radiator 541 and the conductor 547 are connected. For example, a connection structure for connecting the antenna radiator 541 and the PCB 543 may be disposed in the first portion 551, and a connection structure for connecting the antenna radiator 541 and the conductor 547 (or the antenna radiator 541, the PCB 543, and the conductor 547) may be disposed in the second portion 552. As described above, the conductor 547 and the antenna radiator 541 or the PCB 543 and the antenna radiator 541 may be electrically connected.

Referring to FIG. 5C, the electronic device 101 may include an antenna radiator 571 (e.g., the antenna radiator 311 of FIG. 3A, the antenna radiator 361 of FIG. 3B), a PCB 573 (e.g., the PCB 313 of FIG. 3A, the PCB 363 of FIG. 3B), and an electrical conductor 577 (e.g., the conductor 317 of FIG. 3B, the conductor 367 of FIG. 3A). The antenna radiator 571, the PCB 573, and the conductor 577 included in the electronic device 101 may be included in a housing 505 (e.g., the housing 305 of FIG. 3A, the housing 355 of FIG. 3B). For example, the housing 505 may be formed in a ring shape. FIG. 5C illustrates a planar state in which the ring-shaped housing 505 is enlarged, for convenience of description. Unlike the connection state of FIGS. 5A and 5B, the antenna radiator 571 and the PCB 573 may be disposed on different layers. For example, the antenna radiator 571 and the PCB 573 may be disposed on a layer between the outer surface 505-2 and the inner surface 505-1 of the housing 505. According to an embodiment, the antenna radiator 571 may be electrically connected to the PCB 573 in order to be fed with signals for radiation. For example, the antenna radiator 571 may be electrically connected to the PCB 573 through a coupling member. For example, the coupling member may include a structure for connection through a soldering or a connector. For example, a connector may be disposed on one surface of the PCB 573. The antenna radiator 571 and the PCB 573 may be connected (connector to connector, CTC) to each other through a connector. For example, the conductor 577 may be connected to the PCB 573 through a soldering or a hook structure (e.g., T-cut hook structure). This may be for connecting the antenna radiator 571 and the conductor 577 coupled with a part of the body acting as a ground, when the user wears the electronic device 101. In FIG. 5C, the conductor 577 may be connected to the antenna radiator 571 through a PCB 573.

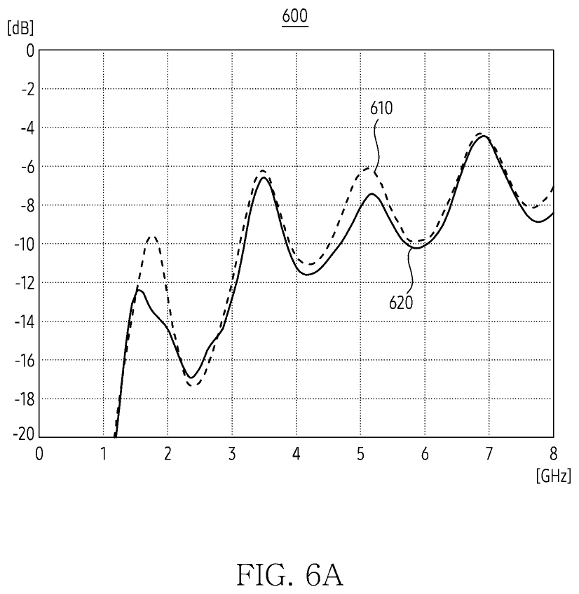

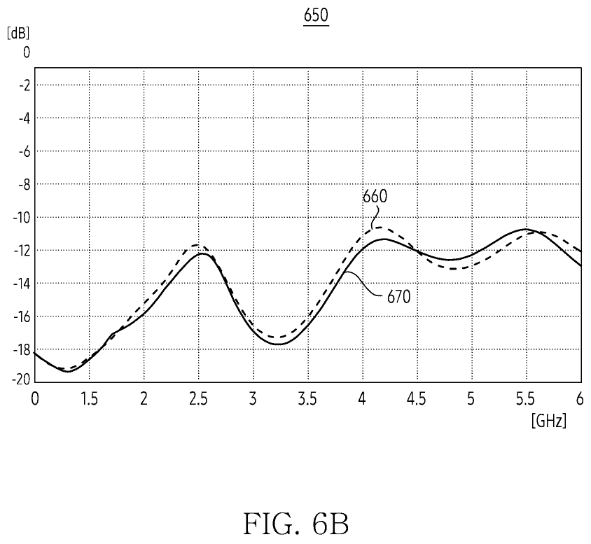

FIGS. 6A and 6B are graphs illustrating examples of the performance of an electronic device when the user's body is used as a ground, according to various embodiments of the disclosure. The user may refer to a person wearing the electronic device. The electronic device may be a wearable device that may be worn by a user. The electronic device of FIG. 6A may be an example of the electronic device 101 of FIG. 1.

FIG. 6A illustrates a graph 600 including a first line 610 illustrating the radiation performance of an antenna of the electronic device, when the user's body is used as a ground (GND), and a second line 620 illustrating the radiation performance of an antenna of the electronic device when the user's body is not used as a ground. In the graph 600, the horizontal axis represents the frequency of the radiated signal (unit: Gigahertz, GHz), and the vertical axis represents the radiation performance (unit: decibel, dB) of the antenna.

Referring to the graph 600, a value of the first line 610 may have a value higher than a value of the second line 620 over the entire frequency band. For example, in 1.8 GHz band, the value of the first line 610 may be about −9.6 dB, and the value of the second line 620 may be a value lower than −12 dB. Further, in 3.5 GHz band, the value of the first line 610 may be about −6.1 dB, and the value of the second line 620 may be about −6.5 dB lower than the value of the first line 610. Further, in 5.1 GHZ band, the value of the first line 610 may be about −6 dB, and the value of the second line 620 may be about −7.8 dB lower than the value of the first line 610. Considering the above, when the user's body is used as a ground of the electronic device, the antenna radiation performance of the electronic device may be improved in a frequency band (e.g., a band of about 1 GHz or more) of a signal radiated by the electronic device. In other words, the quality of a signal radiated by the electronic device through the antenna may be improved.

FIG. 6B illustrates a graph 650 including a third line 660 showing the radiation performance of the antenna of the electronic device, when the antenna and the user's body are directly connected through a conductive portion (e.g., an electrical conductor) of the electronic device, and a fourth line 670 showing the radiation performance of the antenna of the electronic device, when the antenna and the user's body are electromagnetically coupled through the conductive coating layer of the electronic device. Electromagnetically coupling the antenna radiator and the user's body via the conductive portion of the electronic device may include electromagnetically coupling the conductive portion and the user's body instead of direct connection thereof, based on the conductive coating layer forming a non-conductive layer positioned on a surface of the conductive portion (e.g., conductor). In the graph 650, the horizontal axis represents the frequency of the radiated signal (unit: Gigahertz, GHz), and the vertical axis represents the radiation performance (unit: decibel, dB) of the antenna.

Referring to the graph 650, in a frequency band equal to or less than about 4.5 GHZ, a value of the third line 660 may have a high value of the fourth line 670. For example, in a band of about 2.5 GHZ, the value of the third line 660 may be about −11.8 dB, and the value of the fourth line 670 may be a value less than −12 dB. Further, in a band of about 4.2 GHZ, the value of the third line 660 may be about −10.8 dB, and the value of the fourth line 670 may be about −11.5 dB, which is lower than the value of the third line 660. Further, in a band of about 4.5 GHZ to 5.5 GHZ, the third line 660 and the fourth line 670 may have similar values. After about 5.5 GHZ, the value of the third line 660 may have a value higher than the value of the fourth line 670. In view of the foregoing, the electromagnetic coupling of the antenna and the user's body via the conductive portion of the electronic device (e.g., an electrical conductor) may improve the antenna radiation performance of the electronic device in a specific frequency band (e.g., a band of about 1 GHz to about 4.5 GHZ, or a band above about 5.5 GHZ) of signals radiated by the electronic device, as compared to not doing so. In other words, when the conductive portion of the electronic device is coated, the quality of the signal radiated through the antenna radiator in a specific frequency band may be improved.

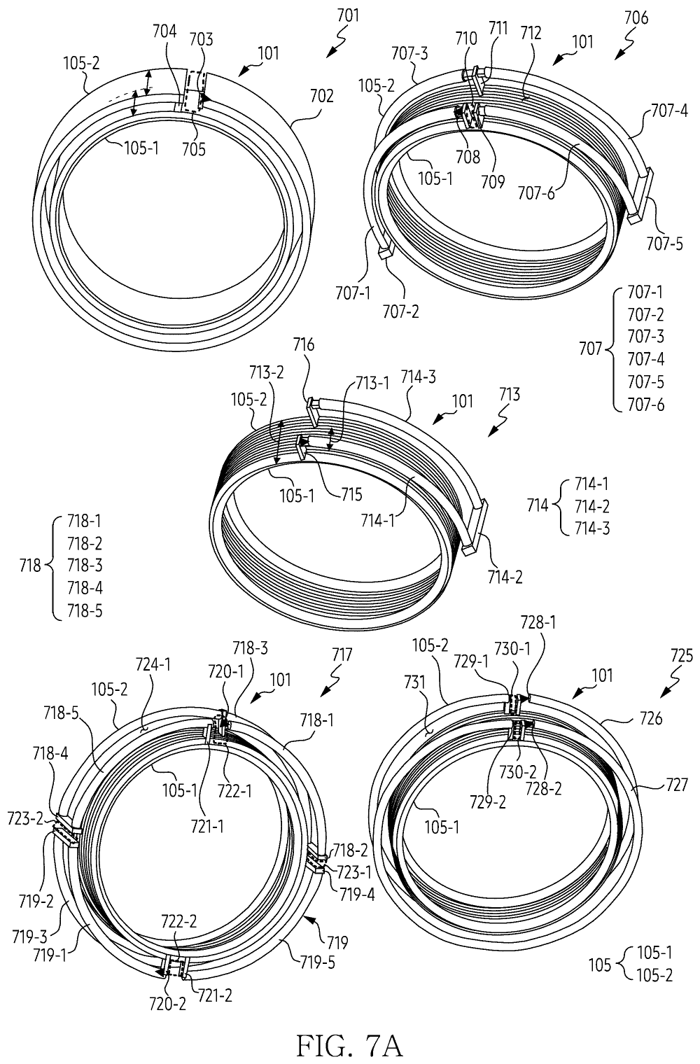

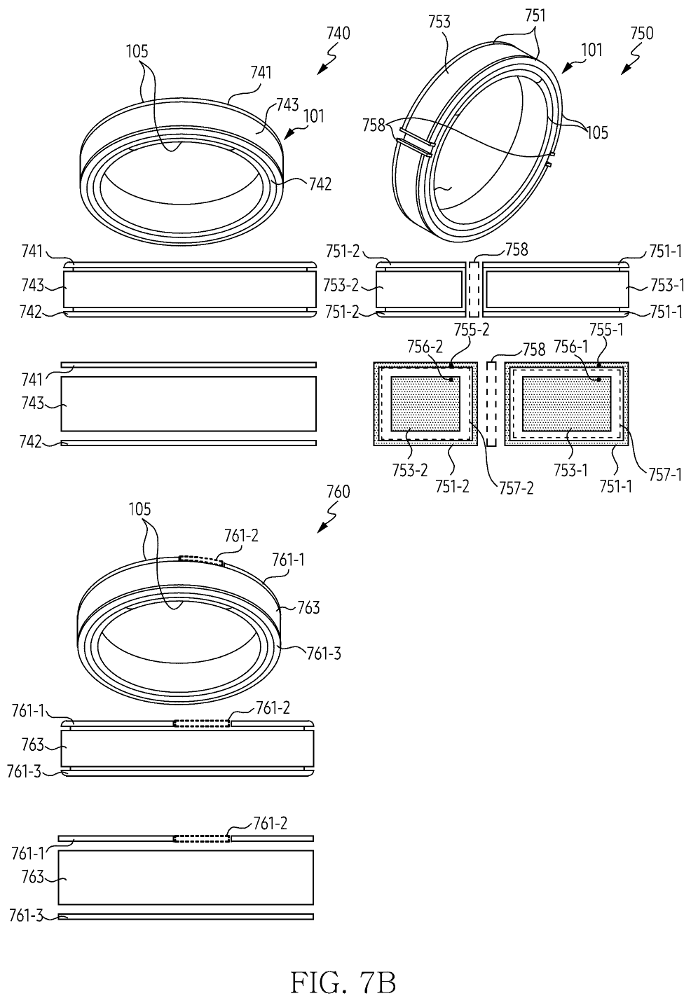

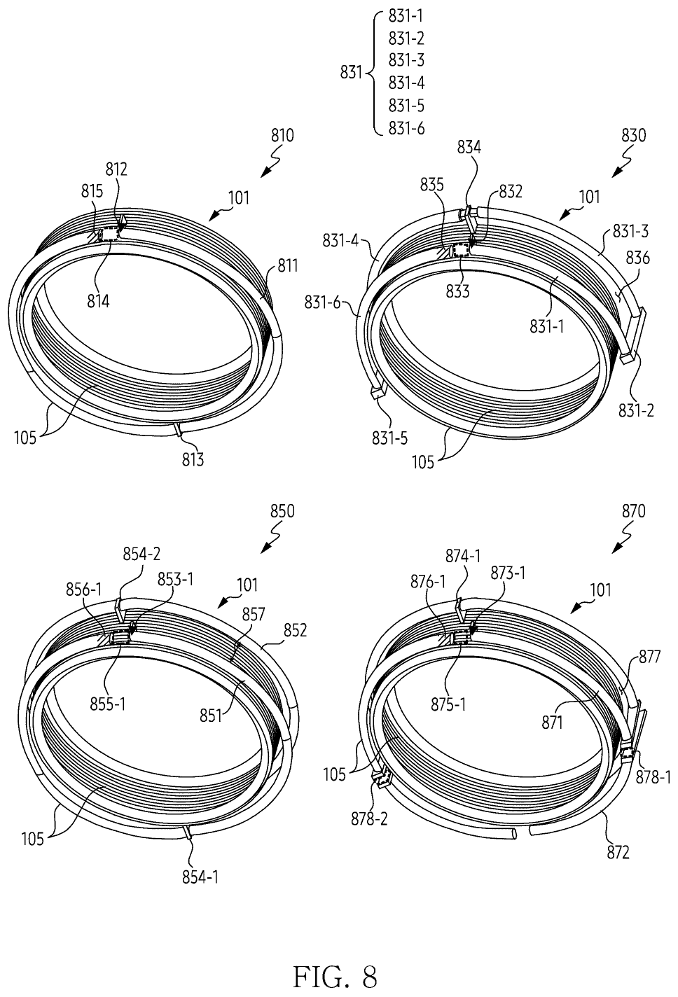

FIGS. 7A and 7B illustrate various examples of an electronic device according to an antenna structure according to various embodiments of the disclosure. FIG. 8 illustrates various examples of an electronic device according to an antenna structure according to an embodiment of the disclosure. Each of the electronic devices 101 of FIGS. 7A, 7B, and 8 may be understood in substantially the same manner as the electronic device 101 of FIG. 1 and the electronic device 101 of FIG. 2. For example, the housing 105 of each of the electronic devices 101 of FIGS. 7A, 7B, and 8 may include an inner surface 105-1 and an outer surface 105-2.

The electronic devices 101 of FIGS. 7A, 7B, and 8 may be classified according to the structure of the antenna radiator or the number of antenna radiators. For example, the electronic devices 101 of FIG. 7A may be examples of an electronic device 101 including a loop shaped antenna radiator. The electronic devices 101 of FIG. 7B may be examples of an electronic device 101 including an antenna radiator of a slot shape. The electronic devices 101 of FIG. 8 may be examples of an electronic device 101 including an inverted F antenna (IFA).

Referring to FIG. 7A, a first example 701, a second example 706, a third example 713, a fourth example 717, and a fifth example 725 of an electronic device 101 including a loop antenna are found. Referring to the first example 701, the electronic device 101 may include an antenna radiator 702 extending in a ring shape along the housing 105 in an area (e.g., a layer) corresponding to the housing 105. The antenna radiator 702 may include a ring-shaped conductive member formed as a plate. For example, a width of the antenna radiator 702 (or a conductive portion) may correspond to a width of the housing 105. The meaning of the term “corresponding to” may imply that the width of the antenna radiator 702 is substantially the same as the width of the housing 105.

Referring to the first example 701, the antenna radiator 702 may be electrically connected to a wireless communication circuit (not shown) of the electronic device 101 through a second coupling member 703. The antenna radiator 702 may be fed with signals from the wireless communication circuit. For example, the second coupling member 703 may be referred to as a feeding part. For example, the antenna radiator 702 may include a segmented portion 705. The electronic device 101 may include a first coupling member 704 for connection with a ground (e.g., a body of a user) of the antenna radiator 702. For example, the first coupling member 704 may be disposed to be spaced apart from the second coupling member 703 with the segmented portion 705 interposed therebetween. However, the disclosure is not limited thereto. The positions of the first coupling member 704, the second coupling member 703, and the segmented portion 705 may be changed depending on the structure of the electronic device 101 or the frequency band supported by the antenna radiator 702.

Referring to the second example 706, the electronic device 101 may include an antenna radiator 707 extending in a ‘□’-shape (or a dual U-shape) along the housing 105 on an area (e.g., a layer) corresponding to the housing 105. The ‘□’-shaped antenna radiator may refer to a structure including two U-shaped antenna radiators. The antenna radiator 707 may include a ‘□’-shaped conductive member formed of edges. The conductive member formed of the edges may represent a band-shaped conductive member. For example, the antenna radiator 707 may include a first edge 707-1 extending in a counterclockwise direction (hereinafter, in a first direction) along the housing 105 from a portion connected to a second coupling member 703 which is a feeding part, a second edge 707-2 extending from the first edge 707-1 and extending in a second direction perpendicular to the first direction, and a third edge 707-3 extending from the second edge 707-2 and extending in a clockwise direction (hereinafter, in a third direction) opposite to the first direction. The third edge 707-3 may be connected at a support member 711. For example, the support member 711 may be formed of a non-conductive member. Further, the antenna radiator 707 may include a fourth edge 707-4 extending from the support member 711 in the third direction at the third edge 707-3, a fifth edge 707-5 extending from the fourth edge 707-4 and extending in a fourth direction perpendicular to the third direction, and a sixth edge 707-6 extending from the fifth edge 707-5 and extending in the first direction. The sixth edge 707-6 may be connected to the first coupling member 709 for connecting the antenna radiator 707 to the ground. Each of the set of the first edge 707-1, the second edge 707-2, and the third edge 707-3, and the set of the fourth edge 707-4, the fifth edge 707-5, and the sixth edge 707-6 may be formed in a U-shape. The two sets may be formed in the ‘□’-shape. A width of each of the first edge 707-1 to the sixth edge 707-6 may be formed to be narrower than a width of the housing 105, and a width of each of the first edge 707-1 to the sixth edge 707-6 may correspond to each other.

Referring to the second example 706, the antenna radiator 707 may include an opening 712. For example, then opening 712 may be positioned between the first edge 707-1 and the third edge 707-3, and the first edge 707-1 and the third edge 707-3 may be disposed to be spaced apart from each other. The opening 712 may be positioned between the fourth edge 707-4 and the sixth edge 707-6, and the fourth edge 707-4 and the sixth edge 707-6 may be disposed to be spaced apart from each other.

Referring to the second example 706, the antenna radiator 707 may include a segmented portion 710. For example, the segmented portion 710 may be located between the first edge 707-1 and the sixth edge 707-6. However, the disclosure is not limited thereto. The positions of the first coupling member 709, the second coupling member 708, and the segmented portion 710 may be changed depending on the structure of the electronic device 101 or the frequency band supported by the antenna radiator 707.

Referring to the third example 713, the electronic device 101 may include an antenna radiator 714 extending in a U-shape along the housing 105 on an area (e.g., a layer) corresponding to the housing 105. The antenna radiator 714 may include a U-shaped conductive member formed of edges. The conductive member formed of the edges may represent a strip-shaped conductive member. For example, the antenna radiator 714 may include a first edge 714-1 extending in a clockwise direction (hereinafter, in a first direction) along the housing 105 from a portion connected to the second coupling member 715 which is a feeding part, a second edge 714-2 extending in a second direction perpendicular to the first direction from the first edge 714-1, and a third edge 714-3 extending in a counterclockwise direction (hereinafter, in a third direction) opposite to the first direction from the second edge 174-2. The third edge 714-3 may be connected to a first coupling member 716 which is a ground part. In an embodiment, the conductive pattern including the first edge 714-1, the second edge 714-2, and the third edges 714-3 may be formed in a U-shape. For example, the first edge 714-1 and the third edge 714-3 may be disposed to be spaced apart from each other. A width 713-1 of each of the first edge 714-1 and the third edge 714-3 may be formed to be narrower than a width 713-2 of the housing 105, and a width of the first edge 714-1 may correspond to a width of the third edge 714-3. The third example 713 discloses the electronic device 101 including one U-shaped antenna radiator 714, but the disclosure is not limited thereto. For example, as in the fourth example 717, the electronic device 101 may include a plurality of conductive patterns formed in the U-shape disposed at positions symmetrical to the center of the electronic device 101. Further, as in the second example 706, the disclosure may include the electronic device 101 including an antenna having a structure in which an edge is further extended from one edge (e.g., the third edge 714-3).

Referring to the fourth example 717, according to an embodiment, the electronic device 101 may include a first antenna radiator 718 and a second antenna radiator 719 extending along the housing 105 in a partial ring or loop shape on an area corresponding to the housing 105. The partial ring or loop shape is formed in a ring shape in the exterior appearance, but the size of the ring (e.g., a half-ring, a partial-ring) may be formed to correspond to a portion of the shape of the housing 105. For example, the electronic device 101 may include a plurality of conductive patterns in a ring shape. For example, the plurality of conductive patterns may operate as antenna radiators. The first antenna radiator 718 may include a first edge 718-1 extending in a clockwise direction (hereinafter, in a first direction) along the housing 105, a second edge 718-2 extending in a direction perpendicular to the first direction from the first edge 718-1, a third edge 718-3 extending in a counterclockwise direction (hereinafter, in a second direction) from the second edge 718-2, a fourth edge 718-4 extending in a direction perpendicular to the second direction from the third edge 718-3, and a fifth edge 718-5 extending in the first direction from the fourth edge 718-4. The first antenna radiator 718 may include an opening 724-1. For example, the opening 724-1 may be located between the first edge 718-1 and the third edge 718-3, and the first edge 718-1 and the third edge 718-3 may be spaced apart from each other. The opening 724-1 may be positioned between the fifth edge 718-5 and the third edge 718-3, and the fifth edge 718-5 and the third edge 718-3 may be spaced apart from each other. Further, the first antenna radiator 718 may include a segmented portion 722-1. For example, the segmented portion 722-1 may be positioned between the first edge 718-1 and the fifth edge 718-5. Therefore, the first edge 718-1 may be disposed to be spaced apart from the fifth edge 718-5. According to an embodiment, the first antenna radiator 718 may be connected to a second coupling member 720-1 which is a feeding part. For example, the second coupling member 720-1 may be connected to the first edge 718-1. The first antenna radiator 718 may be connected to a first coupling member 721-1 which is a ground part. For example, the first coupling member 721-1 may be connected to the fifth edge 718-5. However, the disclosure is not limited thereto. The positions of the first coupling member 721-1, the second coupling member 720-1, and the segmented portion 722-1 may be changed depending on the structure of the electronic device 101 or the frequency band supported by the first antenna radiator 718.

According to an embodiment, a width of each of the first edge 718-1 and the third edge 718-3 may be formed to be narrower than a width of the housing 105, and widths of the first edge 718-1 and the third edge 718-3 may correspond to each other.

According to an embodiment, the structure of the second antenna radiator 719 may be substantially the same as and symmetrical to that of the first antenna radiator 718. For example, the structure of the second antenna radiator 719 may be formed in a structure symmetrical with respect to the center of the electronic device 101. A description of the second antenna radiator 719 may be substantially the same as the description of the first antenna radiator 718. For example, the second antenna radiator 719 may include a plurality of conductive patterns. The plurality of conductive patterns may include a first edge 719-1, a second edge 719-2, a third edge 719-3, a fourth edge 719-4, and a fifth edge 719-5. The second antenna radiator 719 may include a segmented portion 722-2 and an opening. For example, the segmented portion 722-2 may be positioned between the first edge 719-1 and the fifth edge 719-5. The opening may be positioned in an area between the first edge 719-1 and the third edge 719-3, and may be positioned in an area between the fifth edge 719-5 and the third edge 719-3. The first edge 719-1 may be connected to the second coupling member 720-2 which is a feeding part. The fifth edge 719-5 may be connected to the first coupling member 721-2 which is a ground part. However, the disclosure is not limited thereto. The positions of the first coupling member 721-2, the second coupling member 720-2, and the split part 722-2 may be changed depending on the structure of the electronic device 101 or the frequency band supported by the second antenna radiator 719.

In this case, the second antenna radiator 719 and the first antenna radiator 718 may be spaced apart from each other on a virtual surface (layer). In this case, space apart regions 723-1 and 723-2 may be included between the second antenna radiator 719 and the first antenna radiator 718. Although not shown in FIG. 7A, the regions 723-1 and 723-2 may include non-conductive members. For example, non-conductive members may exist in each of the regions 723-1 and 723-2, and accordingly, the first antenna radiator 718 and the second antenna radiator 719 may be spaced apart from each other. In the electronic device 101 of the fourth example 717, the frequency band (or resonance frequency) supported by the first antenna radiator 718 or the second antenna radiator 719 may be changed by adjusting the gap of the regions 723-1 and 723-2 between the first antenna radiator 718 and the second antenna radiator 719.

The first antenna radiator 718 and the second antenna radiator 719 do not extend completely along the ring-shaped housing 105 of the electronic device 101 but extend partially along the housing 105, and may be referred to as an antenna of a half-ring or partial ring structure.

Referring to the fifth example 725, the electronic device 101 may include a first antenna radiator 726 and a second antenna radiator 727 extending in a ring shape along the housing 105 on an area (e.g., a layer) corresponding to the housing 105. Each of the first antenna radiator 726 and the second antenna radiator 727 may include a conductive member formed of a ring-shaped edge. For example, the first antenna radiator 726 may include a ring-shaped conductive pattern extending along one edge of the housing 105. The second antenna radiator 727 may include a ring-shaped conductive pattern extending along another edge of the housing 105. For example, the first antenna radiator 726 may include an edge extending in a clockwise direction (hereinafter, in a first direction) along the housing 105 from a portion connected to the second coupling member 728-1, which is a feeding part. The edge may be connected to a first coupling member 729-1 which is a ground part. The ring-shaped first antenna radiator 726 may include a segmented portion 730-1. A width of the edge may be formed to be narrower than a width of the housing 105. According to an embodiment, the second antenna radiator 727 may have substantially the same structure as the second antenna radiator 727. For example, the second antenna radiator 727 may include a second coupling member 728-2 which is a feeding part, and may include a first coupling member 729-2 which is a ground part. The second antenna radiator 727 may include a segmented portion 730-2. For example, the segmented portion 730-2 may be positioned between the first coupling member 729-2 and the second coupling member 728-2. According to an embodiment, the electronic device 101 may include an opening 731. For example, the opening 731 may be positioned in an area between the first antenna radiator 726 and the second antenna radiator 727.

However, the disclosure is not limited thereto, and the first antenna radiator 726 may be formed such that the positions of the second coupling members 728-1 and 728-2, which are feeding parts, or the first coupling members 729-1 and 729-2, which are ground parts, are different from those of the second antenna radiator 727, or the lengths of edges are different therefrom. The positions of the first coupling members 729-1 and 729-2, the second coupling members 728-1 and 730-2 and the segmented portions 730-1 and 730-2 may be changed depending on the structure of the electronic device 101 or the frequency band supported by the antenna radiators 728 and 729. Further, the fifth example 725 of FIG. 7A discloses an electronic device 101 including the ring-shaped first antenna radiator 726 and second antenna radiator 727 formed as edges, but the disclosure is not limited thereto. The disclosure may also include an electronic device 101 including one ring-shaped antenna radiator formed of an edge.

FIG. 7B discloses a sixth example 740, a seventh example 750, and an eighth example 760 for an electronic device 101 including a slot antenna.

In an embodiment of the disclosure, referring to the sixth example 740, the electronic device 101 may include antenna radiators 741 to 743 extending to form a slot structure along the housing 105 in an area (e.g., a layer) corresponding to the housing 105. For example, the slot structure may refer to a structure in which a gap between two different components is spaced apart to form a slender hole. The antenna radiators 741 to 743 may include a plurality of parts. For example, the antenna radiators 741 to 743 may include a first portion 741, a second portion 742, and a third portion 743. For example, the first portion 741 may include a first edge which is a ring-shaped conductive member extending along the housing 105. The second portion 742 may include a second edge which is a ring-shaped conductive member extending along the housing 105. The first edge and the second edge may be disposed to be spaced apart from each other. The third portion 743 may be disposed between the first portion 741 and the second portion 742. The third portion 743 may be spaced apart from each of the first portion 741 and the second portion 742 and formed in a ring shape along the housing 105. Accordingly, the slot structure may be formed between the first portion 741 and the third portion 743, and between the second portion 742 and the third portion 743. For example, the third portion 743 may have a ring shape formed as a flat surface, unlike the first edge of the first portion 741 and the second edge of the second portion 742. For example, a width of the third portion 743 may be greater than a width of the first portion 741 and a width of the second portion 742.

In an embodiment of the disclosure, referring to the seventh example 750, the electronic device 101 may include antenna radiators 751-1, 753-1, 751-2, and 753-2 extending to form a structure including a plurality of slots along the housing 105 on an area (e.g., a layer) corresponding to the housing 105. The structure including a plurality of slots may refer to a structure in which a plurality of slot structures of a ‘□’-shape exist. For example, the electronic device 101 may include first antenna radiators 751-1 and 753-1 forming a slot structure of a ‘□’-shape and/or second antenna radiators 751-2 and 753-2 forming a slot structure of a ‘□’-shape. Each of the first antenna radiators 751-1 and 753-1 and the second antenna radiators 751-2 and 753-2 may include a conductive member implemented with a plurality of parts. For example, the first antenna radiators 751-1 and 753-1 may include a first portion 751-1 and a second portion 753-1. The first portion 751-1 may extend clockwise along the housing 105 from a point connected to the second coupling member 755-1 which is a feeding part. The first portion 751-1 may be a conductive member including an opening 757-1 having a ‘□’-shape therein, and extending along the edge of the inner surface 105-1 of the housing 105. The first portion 751-1 may be connected to the second coupling member 755-1 which is a feeding part. The second portion 753-1 may be a plate-shaped conductive member which extends along the housing 105 and is located in the opening 757-1 formed by the first portion 751-1. In other words, the second portion 753-1 may be disposed to be spaced apart from the first portion 751-1 in the opening 757-1 formed by the structure of the first portion 751-1. The first portion 751-1 and the second portion 753-1 in the first portion 751-1 may form a slot structure having a ‘□’-shape. In this case, a width of edges forming the first portion 751-1 may be formed to be narrower than a width of a surface forming the second portion 753-1. The second portion 753-1 may be connected to the first coupling member 756-1 which is a ground part.

For example, the second antenna radiators 751-2 and 753-2 may include a first portion 751-2 and a second portion 753-2. The first portion 751-2 may extend clockwise along the housing 105 from a point connected to the second coupling member 755-2 which is a feeding part. The first portion 751-2 may be a conductive member including an opening 757-2 having a ‘□’-shape therein, and extending along the edge of the inner surface 105-1 of the housing 105 along the housing 105. The first portion 751-2 may be connected to the second coupling member 755-2 which is a feeding part. The second portion 753-2 may be a plate-shaped conductive member which extends along the housing 105 and is located in the opening 757-2 formed by the first portion 751-2. In other words, the second portion 753-2 may be disposed to be spaced apart from the first portion 751-2 in the opening 757-2 formed by the structure of the first portion 751-2. The first portion 751-2 and the second portion 753-2 in the first portion 751-2 may form a slot structure having an ‘□’-shape. In this case, widths of the edges forming the first portion 751-2 may be formed to be narrower than widths of the surface forming the second portion 753-2. The second portion 753-2 may be connected to the first coupling member 756-2 which is a ground part.

According to the above description, the first antenna radiators 751-1 and 753-1 may be slot antennas that use a region of a ‘□’-shaped slot structure formed by the first portion 751-1 and the second portion 753-1 as a radiation area. For example, as the first portion 751-1 is connected to the second coupling member 755-1 to feed power from the wireless communication circuit, and the second portion 753-1 is connected to the first coupling member 756-1 to be grounded, the area of the ‘□’-shaped slot structure may operate as a radiation area. According to an embodiment, by adjusting sizes of the first portion 751-1 and the second portion 753-1, it is possible to adjust an electrical length of the slot structure, and thus it is possible to adjust a resonance frequency of a signal radiated by the first antenna radiators 751-1 and 753-1. The second antenna radiators 751-2 and 753-2 may be a slot antenna that uses an area of a ‘□’-shaped slot structure formed by the first portion 751-2 and the second portion 753-2 as a radiation area. For example, as the first portion 751-2 is connected to the second coupling member 755-2 to feed a signal from the wireless communication circuit, and the second portion 753-2 is connected to the first coupling member 756-2 to be grounded, the area of ‘□’-shaped slot structure may operate as a radiation area. According to an embodiment, an electrical length of the slot structure may be adjusted by adjusting sizes of the first portion 751-2 and the second portion 753-2, and thus a resonance frequency of a signal radiated by the second antenna radiators 751-2 and 753-2 may be adjusted.

In an embodiment, the second antenna radiators 751-2 and 753-2 may be formed substantially the same as the first antenna radiators 751-1 and 753-1. For example, the second antenna radiators 751-2 and 753-2 may be disposed to be symmetrical to the first antenna radiators 751-1 and 753-1 with respect to the center of the electronic device 101. The first antenna radiators 751-1 and 753-1 may be disposed to be spaced apart from the second antenna radiators 751-2 and 753-2. In other words, a spaced area 758 may be included in between the first antenna radiators 751-1 and 753-1 and the second antenna radiators 751-2 and 753-2. In an embodiment, only one of the first antenna radiators 751-1 and 753-1 and the second antenna radiators 751-2 and 753-2 may be electrically connected to the wireless communication circuit to operate as an antenna.

Referring to the eighth example 760, the electronic device 101 may include antenna radiators 761-1, 761-2, 761-3, and 763 extending to form a hybrid slot structure along the housing 105 on an area (e.g., a layer) corresponding to the housing 105. The hybrid slot structure may refer to a structure including a dual slot structure in some regions and a single slot structure in other regions. For example, the antenna radiators 761-1, 761-2, 761-3, and 763 of the eighth example 760 may have a structure in which a second portion 761-2, which is a segmented part, is formed on a portion (e.g., a first portion 731) of the antenna radiators 731, 732, and 733 of the sixth example 740.

According to an embodiment, the antenna radiators 761-1, 761-2, 761-3, and 763 may include a conductive member implemented with a plurality of portions. For example, the antenna radiators 761-1, 761-2, 761-3, and 763 may include a first portion 761-1, a second portion 761-2, a third portion 761-3, and a fourth portion 763. The first portion 761-1 may include a ring-shaped first edge extending clockwise along the housing 105 from a first point connected to the coupling member, which is a feeding part. The first portion 761-1 may include a second portion 761-2, which is a segmented portion, in a portion of the first edge. The third portion 761-3 may include a second edge of a ring-shape extending clockwise along the housing 105 from a second point connected to the coupling member, which is a feeding part. Unlike the first portion 761-1, the third portion 761-3 does not include a second portion 761-2, which is a segmented portion. The first point and the second point may be different from each other, and the first edge and the second edge may be spaced apart from each other. The fourth portion 763 may be disposed between the first portion 761-1 and the third portion 761-3, and the fourth portion 763 may be spaced apart from each of the first portion 761-1 and the third portion 761-3. Accordingly, the antenna radiators 761-1, 761-2, 761-3, and 763 may include a slot structure. In this case, in an area in which the fourth portion 763 and the second portion 761-2 overlap, the electronic device 101 of the eighth example 760 may include only a single slot structure formed by the third portion 761-3 and the fourth portion 763. In other area (i.e., an area where the first portion 761-1 and the fourth portion 763 overlap other than the second portion 761-2), the electronic device 101 of the eighth example may include a double slot structure. Although the electronic device 101 of the eighth example 760 illustrates an example of including the second portion 761-2, which is a single segmented portion, the disclosure is not limited thereto. The disclosure may include an electronic device 101 including a plurality of segmented portions.

FIG. 8 illustrates a ninth example 810, a tenth example 830, an eleventh example 850, and a twelfth example 870 of the electronic device 101 including an IFA antenna according to an embodiment of the disclosure.

Referring to the ninth example 810, according to an embodiment, the electronic device 101 may include an antenna radiator 811 extending in a ring shape along the housing 105 on an area (e.g., a layer) corresponding to the housing 105. The antenna radiator 811 may include a conductive member formed as a ring-shaped edge including one segmented portion 814. For example, the antenna radiator 811 may include an edge extending in a clockwise direction (hereinafter, referred to as a first direction) along the housing 105 from a portion connected to a second coupling member 812 which is a feeding part. The edge may be formed in a ring shape. The edge may be connected to a first coupling member 813 which is a ground part. The ring-shaped antenna radiator 811 may include a segmented portion 814.

The antenna radiator 811 of the ninth example 810 may be referred to as a full IFA. For example, the edge may extend from the second coupling member 812 to the segmented portion 814 passing through the first coupling member 813, and the edge may include a portion 815 terminated in an area adjacent to the segmented portion 814. Although not shown in FIG. 8, the electronic device 101 of the ninth example 810 may also include a case where the antenna radiator 811 is a monopole antenna. For example, when the first coupling member 813 is opened, the antenna radiator 811 may operate as a monopole antenna.

Referring to the tenth example 830, the electronic device 101 may include an antenna radiator 831 extending in a ‘□’-shape (or a dual U-shape) along the housing 105 on an area (e.g., a layer) corresponding to the housing 105. The antenna radiator 831 may include a ‘□’-shaped conductive member formed of edges. For example, the antenna radiator 831 may include a first edge 831-1 extending in a counterclockwise direction (hereinafter, in a first direction) along the housing 105 from a portion connected to the second coupling member 832 which is a feeding part, a second edge 831-2 extending in a second direction perpendicular to the first direction from the first edge 831-1, and a third edge 831-3 extending in a clockwise direction (hereinafter, a third direction) opposite to the first direction from the second edge 831-2. The third edge 831-3 may be connected to a first coupling member 834 which is a ground part. Further, the antenna radiator 831 may include a fourth edge 831-4 extending from the first coupling member 834 in the third direction at the third edge 831-3, a fifth edge 831-5 extending from the fourth edge 831-4 and perpendicular to the third direction, and a sixth edge 831-6 extending from the fifth edge 831-5 and extending in the first direction. The antenna radiator 831 of the tenth example 830 may be referred to as a half IFA. For example, the sixth edge 831-6 may include a portion 835 extending from the fifth edge 831-5 and terminating in an area adjacent to the segmented portion 833.

According to an embodiment, the antenna radiator 831 may include an opening 836. For example, a set of the first edge 831-1, the second edge 831-2, and the third edge 831-3 and a set of the fourth edge 831-4, the fifth edge 831-5, and the sixth edge 831-6 may each be formed in a U-shape. The two sets may be formed in a ‘□’-shape. The opening 836 may be formed with a ‘□’-shaped structure formed by the two sets. A width of each of the first edge 831-1 to the sixth edge 831-6 may be formed to be narrower than a width of the housing 105, and a width of each of the first edge 831-1 to the sixth edge 831-6 may correspond to each other. The opening 836 may be positioned between the first edge 831-1 and the third edge 831-3, and the first edge 831-1 and the third edge 831-3 may be disposed to be spaced apart from each other. The opening 836 may be located between the fourth edge 831-4 and the sixth edge 831-6, and the sixth edge 831-4 and the sixth edge 831-6 may be spaced apart from each other. Further, although not shown in FIG. 8, the electronic device 101 of the tenth example 830 may also include a case where the antenna radiator 831 is a monopole antenna. For example, when the first coupling member 834 is opened, the antenna radiator 831 may operate as a monopole antenna.

Referring to the eleventh example 850, the electronic device 101 may include antenna radiators 851 and 852 including a plurality of full IFAs. That is, the antenna radiators 851 and 852 may include the first antenna radiator 851 and the second antenna radiator 852, which are complete IFAs. Each of the first antenna radiator 851 and the second antenna radiator 852 may be formed to have the same structure as the antenna radiator 811 of the ninth example 810. Hereinafter, therefore, a description of a detailed structure of each of the first antenna radiator 851 and the second antenna radiator 852 will be omitted. An edge of the first antenna radiator 851, which is a conductive member, may include a portion 856-1 starting to extend from the second coupling member 853-1 which is a feeding part, passing through the first coupling member 854-1 which is a ground part, and terminating in an area adjacent to the first segmented portion 855-1. The edge, which is a conductive member of the second antenna radiator 852, may include a portion (not shown) that starts extending from the second coupling member (not shown) that is a feeding part, passes through the second coupling member 854-2 that is a ground part, and terminates in an area adjacent to the segmented portion (not shown).

According to an embodiment, the first antenna radiator 851 may be positioned to be spaced apart from the second antenna radiator 852 by a predetermined distance. For example, the first antenna radiator 851 may be positioned to be spaced apart from the second antenna radiator 852 by an area 857. Accordingly, the first antenna radiator 851 may be spaced apart from the second antenna radiator 852. In an embodiment, when the second antenna radiator 852 is not connected to the second coupling member (not shown) that is a feeding part, the second antenna radiator 852 may also operate as a coupling pattern radiator of the first antenna radiator 851. For example, the second antenna radiator 852 may be electromagnetically coupled to the first antenna radiator 852, and may be power-fed from the first antenna radiator 851 via the coupling.

Further, although not shown in FIG. 8, the electronic device 101 of the eleventh example 850 may also include a case where the first antenna radiator 851 or the second antenna radiator 852 is a monopole antenna. For example, when the first coupling member 854-1 is opened, the first antenna radiator 851 may operate as a monopole antenna. The electronic device 101 of the eleventh example (e.g., first antenna radiator 851) may include both the monopole antenna and the IFA antenna. For example, the first antenna radiator 851 may be the IFA antenna shown in FIG. 8, and the second antenna radiator 852 may be a monopole antenna where the first coupling member 854-2 that is a ground part is opened.

Referring to a twelfth example 870, the electronic device 101 may include antenna radiators 871 and 872 including a plurality of half IFAs. For example, the antenna radiators 871 and 872 may include a first antenna radiator 871 and a second antenna radiator 872, which are half IFAs. Each of the first antenna radiator 871 and the second antenna radiator 872 may be implemented in a structure substantially the same as that of the antenna radiator 831 of the tenth example 830. Therefore, hereinafter, a detailed description of the structure of each of the first antenna radiator 871 and the second antenna radiator 872 will be omitted. For example, the first antenna radiator 871 may be connected to the second coupling member 873-1, which is a feeding part. The first antenna radiator 871 may form a ‘□’-shaped structure by edges that are a plurality of conductive members. The first antenna radiator 871 may include an opening 877, and the opening 877 may be located within the ‘□’-shaped structure. The first antenna radiator 871 may be connected to a first coupling member 874-1, which is a ground part. The first antenna radiator 871 may include a segmented portion 875-1. The first antenna radiator 871 may include a portion 876-1 that starts to extend from the second coupling member 873-1, passes through the first coupling member 874-1, and terminates in an area adjacent to the segmented portion 875-1.

According to an embodiment, the first antenna radiator 871 and the second antenna radiator 872 may be spaced apart from each other. For example, areas 878-1 and 878-2 may be included in between the first antenna radiator 871 and the second antenna radiator 872. Although not illustrated in FIG. 8, the areas 878-1 and 878-2 may include non-conductive members. In an embodiment, when the second antenna radiator 872 is not connected to the second coupling member (not shown) that is a feeding part, the second antenna radiator 872 may operate as a coupling pattern radiator of the first antenna radiator 871. For example, the second antenna radiator 872 may be electromagnetically coupled through the areas 878-1 and 878-2 from the first antenna radiator 871, and may be power-fed power from the first antenna radiator 871 through the coupling.

Further, although not shown in FIG. 8, the electronic device 101 of the twelfth example 791 may also include a case where the first antenna radiator 871 or the second antenna radiator 872 is a monopole antenna. For example, when the first coupling member 874-1 is opened, the first antenna radiator 871 may operate as a monopole antenna. The electronic device 101 of the twelfth example 791 may include both the monopole antenna and the IFA antenna. For example, the second antenna radiator 872 may be the IFA antenna shown in FIG. 8, and the first antenna radiator 871 may be the monopole antenna where the first coupling member 874-1 which is a ground part is opened.

Referring to FIGS. 7A, 7B, and 8, the electronic device 101 (e.g., the electronic device 101) of the disclosure may include at least one antenna radiator, and the antenna radiators may be determined in consideration of internal structure, radiation performance, or radiation state of the electronic device 101. For example, when a plurality of components are mounted inside the electronic device 101, the electronic device 101 may include an antenna radiator having a narrow occupied area or an antenna radiator (e.g., the third example 713 of FIG. 7A) that can be disposed in an edge area of the electronic device 101, so as to secure a space. Further, in consideration of the radiation performance or the radiation state, the electronic device 101 may include a plurality of antenna radiators and may select an antenna radiator according to its situation. Such a selection of the antenna radiator may be performed by at least one processor of the electronic device 101.

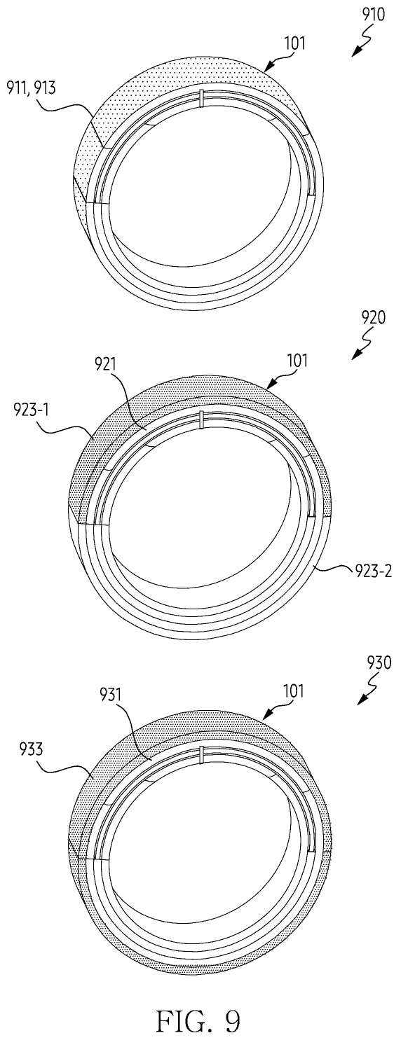

FIG. 9 illustrates various examples of an outer surface of an electronic device according to an embodiment of the disclosure. Each of the electronic devices 101 of FIG. 9 may be understood in the same manner as the electronic device 101 of FIG. 1 and the electronic device 101 of FIG. 2. The outer surface may refer to a part of a ring-shaped housing of the electronic device 101. The outer surface is a part that is exposed to the outside while being worn by the user, and may refer to a surface that faces a direction opposite to the direction in which the inner surface that is not exposed by contact with the user's body faces.

According to an embodiment, an outer surface of the electronic device 101 may be formed of a conductor (or a conductive element). For example, the electronic device 101 of a first case 910 may include an outer surface 913 formed of a conductive member (e.g., a metal). In this case, the outer surface 913 formed of the conductive member may be used as an antenna radiator 911 of the electronic device 101. For example, at least a portion of the outer surface 913 may operate as a radiator of the antenna radiator 911. Although not shown in FIG. 9, the outer surface 913 may include at least one segmented portion in consideration of a frequency band of a radiation signal.

According to an embodiment, the outer surface of the electronic device 101 may be formed of a conductor and a non-conductor. For example, the electronic device 101 of a second case 920 may include a first outer surface 923-1 in a region corresponding to the antenna radiator 921 includes a non-conductor (or a non-conductive member (e.g., a dielectric or the like)). In addition, the electronic device of the second case 920 may include a second outer surface 923-2 in which a region not corresponding to the antenna radiator 921 is formed of a conductor. When the region corresponding to the antenna radiator 921 is formed of a conductor, the antenna radiator 921 is shielded by the first outer surface 923-1 to interfere with radiation of a signal, and thus the first outer surface 923-1 may be formed of a non-conductor. Further, since the second outer surface 923-2 is located in a region that does not affect the radiation of the antenna radiator 921, it may be formed of a conductor. In an embodiment, when the second outer surface 923-2 is formed of a conductor, the second outer surface 923-2 may be connected to a wireless communication circuit to operate as another antenna radiator. For example, referring to a circular loop antenna radiator 702 of the first example 701 of FIG. 7A, the first outer surface 923-1 may be formed of a semicircular loop antenna radiator, and the second outer surface 923-2 may be formed of a remaining semicircular loop antenna radiator. The circular loop antenna radiator of the example may include areas spaced apart between the first outer surface 923-1 and the second outer surface 923-2.

According to an embodiment, an outer surface of the electronic device 101 may be formed of a non-conductor. For example, the electronic device 101 of a third case 930 may include an outer surface 933 formed of a non-conductor. The outer surface 933 may be formed of a non-conductor over the entire area corresponding to the antenna radiator 931. The outer surface 933 including the non-conductive member may physically shield the antenna radiator 931 but may not shield electrically the same, so it may not interfere with the signal radiation of the antenna radiator 931.

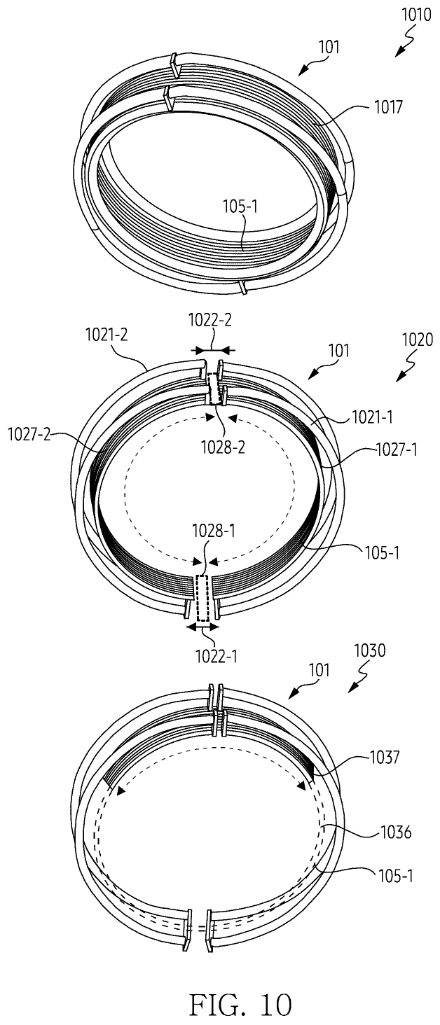

FIG. 10 illustrates various examples of a conductor of an inner surface of an electronic device according to an embodiment of the disclosure. Each of the electronic devices 101 of FIG. 10 may be understood to be substantially the same as the electronic device 101 of FIG. 1 and the electronic device 101 of FIG. 2. The inner surface may refer to a part of a ring-shaped housing that is not exposed by being in contact with the user's body, when the electronic device 101 is worn by the user. For example, the inner surface may refer to a surface that faces in a direction opposite to the direction that the outer side faces, which is a portion of the housing of the electronic device that is exposed to the outside, when worn by a user.

According to an embodiment, the inner surface of the electronic device 101 may include conductors of various shapes. For example, the electronic device 101 of a first case 1010 may include an O-shaped conductor 1017. The electronic device 101 of the first case 1010 may include an O-shaped conductor 1017 having a diameter shorter than that of the ring-shaped outer surface. In the electronic device 101 of the first case 1010, the inner surface may be understood substantially the same as that of the conductor 1017.

For example, the inner surface 105-1 of the electronic device 101 of a second case 1020 may include a first conductor 1027-1 and a second conductor 1027-2 having a ‘( )’ shape. The inner surface 105-1 of the electronic device 101 of the second case 1020 may include at least one segmented portion. The inner surface 105-1 including a plurality of segmented portions 1028-1 and 1028-2 is illustrated in the second case 1020 of FIG. 10, but the disclosure is not limited thereto. According to an embodiment, the electronic device 101 may include an inner surface 105-1 including one segmented portion. In an embodiment, the segmented portions 1028-1 and 1028-2 may include a non-conductive member. For example, the inner surface 105-1 may be formed in a circular structure with the conductors 1027-1 and 1027-2 formed of a conductive member and the segmented portions 1028-1 and 1028-2 formed of a non-conductive members.

According to an embodiment, the positions of the segmented portions 1028-1 and 1028-2 of the electronic device 101 may be changed according to the structure of the antenna radiators 1021-1 and 1021-2 of the electronic device 101. For example, the positions of the first segmented portion 1028-1 and the second segmented portion 1028-2 may correspond to areas 1022-1 and 1022-2 spaced apart between the first antenna radiator 1021-1 and the second antenna radiator 1021-2. For example, the first segmented portion 1028-1 may be positioned to correspond to the first area 1022-1, and the second segmented portion 1028-2 may be positioned to correspond to the second area 1022-2. As the segmented portions 1028-1 and 1028-2 are positioned in the spaced-apart areas 1022-1 and 1022-2 between the antenna radiators 1021-1 and 1021-2, the grounds of the antenna radiators 1021-1 and 1021-2 may be operated separately. Accordingly, coupling or interference between the antenna radiators 1021-1 and 1021-2 may be reduced. Further, a length of the ground or an electrical length of the antenna radiator can be adjusted by adjusting the aligned positions of the segmented portions 1028-1 and 1028-2 and the areas 1022-1 and 1022-2, and the resonant frequency of the first antenna radiator 1021-1 and/or the second antenna radiator 1022-2 can be adjusted.

For example, the inner surface 105-1 of the electronic device 101 of a third case 1030 may include a C-shaped conductor 1037. The electronic device 101 of the third case 1030 may include an inner surface 105-1 including the conductor 1037 in which a portion of the inner surface 105-1 forming a ring shape is a conductive member. For example, a remaining portion 1036 of the inner surface 105-1 may be formed of a non-conductive member. In the example of the third case 1030 of FIG. 10, it is illustrated the inner surface 105-1 in which less than half of the portion forming the ring shape is formed of the conductor 1037, but the disclosure is not limited thereto. The electronic device 101 of the disclosure may include an inner surface 1035 including the conductor 1037 in an area exceeding half of the portion forming the ring shape.

As described above, the electronic device of the disclosure may determine the structure of the inner surface in consideration of the user's wearability, an area in contact with the ground, the weight of the electronic device, or the production cost of the electronic device. For example, in order to reduce the weight of the electronic device in order to reduce the production cost of the electronic device and increase the user's wearability, the electronic device may be formed as the inner surface 105-1 of the third case 1030. Further, in order to increase the surface in contact with the user's body to increase the radiation performance of the electronic device, the electronic device may be formed as the inner surface (or the conductor 1017) of the first case 1010.

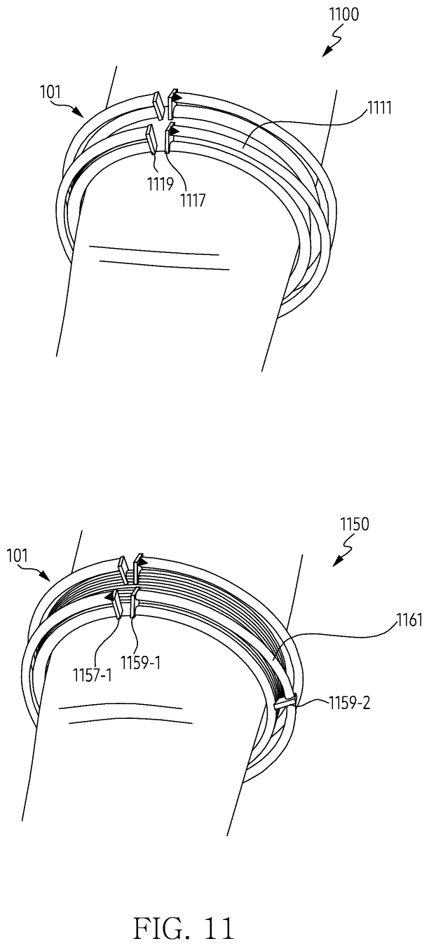

FIG. 11 illustrates various examples of an electronic device according to a grounding method according to an embodiment of the disclosure. Each of the electronic devices of FIG. 11 may be understood in the same manner as the electronic device 101 of FIG. 1 and the electronic device 101 of FIG. 2. The grounding method may refer to a method of connecting a coupling member (or ground part) for grounding to an antenna.

According to an embodiment, the electronic device 101 may include one or more ground parts. For example, the electronic device 101 in the first case 1100 may include one ground part 1119 for the antenna radiator 1111. For example, the electronic device 101 may include a coupling member for grounding. The ground part 1119 may be formed different from a feeding part 1117 of the antenna radiator 1111. For example, the coupling member for forming the ground part 1119 may be different from the coupling member for forming the feeding part 1117 of the antenna radiator 1111.

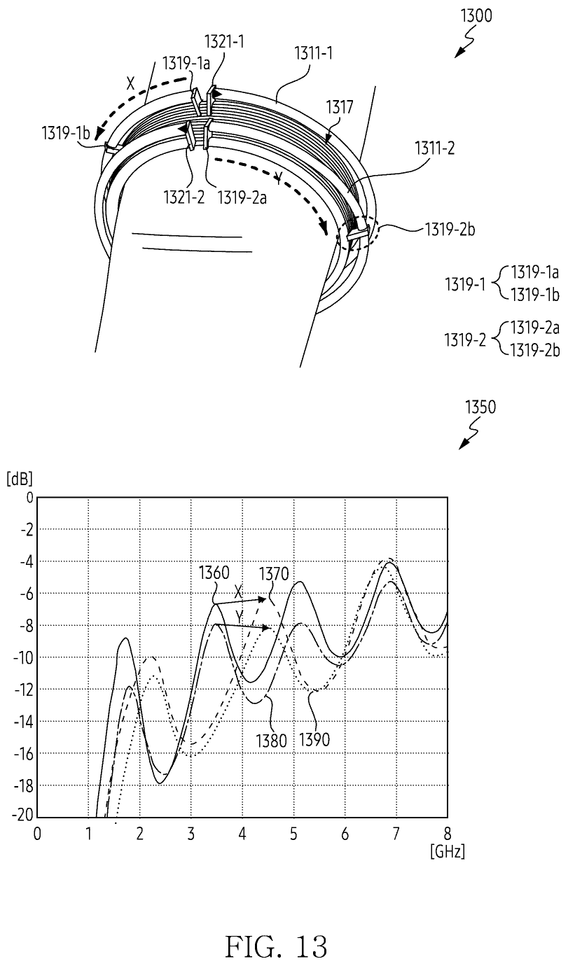

In an embodiment, the electronic device 101 in the second case 1150 may include a plurality of ground parts 1159-1 and 1159-2 for the antenna radiator 1161. For example, the first ground part 1159-1 may be disposed to be spaced apart from a feeding part 1157-1 of the antenna radiator 1161. For example, the second ground part 1159-2 may be disposed at one point moved clockwise along the antenna radiator 1161 from the first ground part 1159-1. Each of the first ground part 1159-1 and the second ground part 1159-2 may include a coupling member for grounding. The frequency of the signal resonated for radiation by the antenna radiator 1161 may be changed depending on the positions of the ground parts 1159-1 and 1159-2. For example, the radiation performance of the antenna radiator 1161 may vary depending on the position of the ground part. Specific details related thereto will be described with reference to FIG. 13 below.

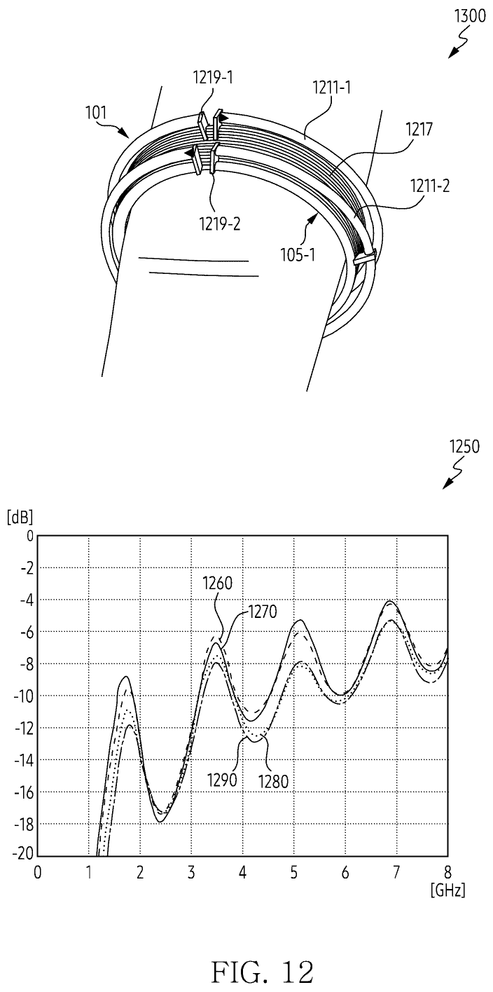

FIG. 12 is a graph illustrating an example of a case in which a plurality of antenna radiators of an electronic device are connected to the same ground, according to an embodiment of the disclosure, and an example of radiation performance of the antenna radiators according thereto. The electronic device 101 of FIG. 12 may be understood in substantially the same manner as the electronic device 101 of FIG. 1 and the electronic device 101 of FIG. 2. The electronic device 101 of FIG. 12 includes two antenna radiators, but the disclosure is not limited thereto. For example, the electronic device 101 may include one antenna radiator or three or more antenna radiators.

Referring to FIG. 12, an example 1200 in a case where a plurality of antenna radiators are connected to the same ground is illustrated. Referring to the example 1200, the electronic device 101 may include a first antenna radiator 1211-1 and a second antenna radiator 1211-2. The electronic device 101 may include a first ground part 1219-1 for connecting the first antenna radiator 1211-1 to the conductor 1217, and a second ground part 1219-2 for connecting the conductor 1217 to the second antenna radiator 1211-2. For example, the ground part may be formed as a coupling member for grounding. For example, the electronic device 101 may include a conductor 1217 connected to the ground. The ground may be a body of the user wearing the electronic device 101. The conductor 1217 may be formed on a part of the inner surface 105-1 of the electronic device 101.

According to an embodiment, the ground for the first antenna radiator 1211-1 and the second antenna radiator 1211-2 of the electronic device 101 may be electrically connected to the first antenna radiator 1211-1 and the second antenna radiator 1211-2 through a conductor 1217. In this case, the ground of the first antenna radiator 1211-1 and the ground of the second antenna radiator 1211-2 may be the same. For example, when the conductor 1217 of the electronic device 101 is positioned close to the body part of the user, the user's body may be used as the ground of the first antenna radiator 1211-1 and the ground of the second antenna radiator 1211-2. Further, the electronic device 101 may include an internal ground including a PCB (not shown) between the inner surface 105-1 and the antenna radiators 1211-1 and 1211-2. The internal ground may be used as the ground of the first antenna radiator 1211-1 and the ground of the second antenna radiator 1211-2.

Referring to FIG. 12, a graph 1250 illustrating the radiation performance of the antenna radiator when the plurality of antenna radiators are connected to the same ground is illustrated. In the graph 1250, the horizontal axis represents the frequency of the radiated signal (unit: Gigahertz, GHz), and the vertical axis represents the radiation performance (unit: decibel, dB) of the antenna. The graph 1250 shows a first line 1260 indicating the radiation performance of the first antenna radiator 1211-1 when the ground of the first antenna radiator 1211-1 and the ground of the second antenna radiator 1211-2 are connected, a second line 1270 indicating the radiation performance of the first antenna radiator 1211-1 when the ground of the first antenna radiator 1211-1 and the ground of the second antenna radiator 1211-2 are separated, and a third line 1280 indicating the radiation performance of the second antenna radiator 1211-2 when the ground of the first antenna radiator 1211-1 and the ground of the second antenna radiator 1211-2 are connected, and a fourth line 1290 indicating the radiation performance of the second antenna radiator 1211-2 when the ground of the first antenna radiator 1211-1 and the ground of the second antenna radiator 1211-2 are separated.

Comparing the first line 1260 with the second line 1270, when the grounds are connected so that the first antenna radiator 1211-1 and the second antenna radiator 1211-2 have the same ground, the radiation performance of the first antenna radiator 1211-1 may be relatively high in a signal of about 3.5 GHz frequency band. When the ground of the first antenna radiator 1211-1 and the second antenna radiator 1211-2 is not connected (e.g., in such a separated case), the radiation performance of the first antenna radiator 1211-1 may be relatively high in a signal of about 5 GHZ frequency band. Comparing the third line 1280 with the fourth line 1290, when the grounds are connected so that the first antenna radiator 1211-1 and the second antenna radiator 1211-2 have the same ground, the radiation performance of the second antenna radiator 1211-2 may be relatively high in the signal of about 3.5 GHz frequency band. Compared with the case where the ground of the first antenna radiator 1211-1 and the second antenna radiator 1211-2 are not connected (in the separated case), the radiation performance of the second antenna radiator 1211-2 may be relatively high in the signal of about 5 GHz frequency band.

Referring to the above description, the ground connection state of the first antenna radiator 1211-1 and the second antenna radiator 1211-2 may vary depending on the frequency band of the signal radiated by the antenna radiator. Further, when the electronic device 101 supports a plurality of frequency bands, the electronic device 101 may operate with different structures for grounding depending on the frequency band. Further, when the antenna radiators are connected to a common ground, the electronic device 101 may secure an installation space capable of sufficiently separating the gaps between the antennas, and may reduce interference.

FIG. 13 is a graph illustrating an example of a case in which a position to be grounded to an electronic device is changed and an example of radiation performance of an antenna radiator, according to an embodiment of the disclosure. The electronic device 101 of FIG. 13 may be understood in substantially the same manner as the electronic device 101 of FIG. 1 and the electronic device 101 of FIG. 2. The electronic device 101 of FIG. 13 includes two antenna radiators, but the disclosure is not limited thereto. For example, the electronic device may include one antenna radiator or three or more antenna radiators.

Referring to FIG. 13, an example 1300 is illustrated when a grounded position of each of a plurality of antenna radiators is changed. Referring to the example 1300, the electronic device 101 may include a first antenna radiator 1311-1 and a second antenna radiator 1311-2. The electronic device 101 may include a first feeding part 1321-1 for feeding a signal to the first antenna radiator 1311-1, or a second feeding part 1321-2 for feeding a signal to the second antenna radiator 1311-2. The electronic device 101 may include a first ground part 1319-1 for connecting the first antenna radiator 1311-1 and the conductor 1317. The electronic device 101 may include a second ground part 1319-2 for connecting the conductor 1317 to the second antenna radiator 1311-2. The feeding part may be formed as a coupling member for feeding power, and the ground part may be formed as a coupling member for grounding. For example, the electronic device 101 may include a conductor 1317 connected to the ground. The ground may include a body of a user wearing the electronic device 101. The conductor 1317 may be formed on a part of the inner surface 105-1 of the electronic device 101.

According to an embodiment, the first antenna radiator 1311-1 of the electronic device 101 may be connected to the ground for the first antenna radiator 1311-1 through the first ground part 1319-1 and the conductor 1317. The second antenna radiator 1311-2 of the electronic device 101 may be connected to the ground for the second antenna radiator 1311-2 through the first ground part 1319-1 and the conductor 1317. For example, the first antenna radiator 1311-1 may be fed with a signal from the wireless communication circuit through the first feeding part 1321-1 disposed at a different position from the first ground part 1319-1. For example, the second antenna radiator 1311-2 may be fed with a signal from the wireless communication circuit through the second feeding part 1321-2 disposed at a different position from the second ground part 1319-2.

According to an embodiment of the disclosure, the position of the first ground part 1319-1 for connecting the first antenna radiator 1311-1 of the electronic device 101 to the ground may be moved counterclockwise (X). For example, the position of the first ground part 1319-1 of the first antenna radiator 1311-1 may be changed from the first ground part 1319-la to the first ground part 1319-1b. Further, the position of the second ground part 1319-2 for connecting the second antenna radiator 1311-2 of the electronic device 101 to the ground may be moved clockwise (Y). For example, the position of the second ground part 1319-2 of the second antenna radiator 1311-2 may be changed from the second ground part 1319-2a to the second ground part 1319-2b. As described above, in a case in which the position of the ground part of the electronic device 101 is changed, the radiation area of the antenna radiator may be changed by the changed position and thus the resonant frequency may be changed. Specific details related thereto are described in the graph 1350 below.

Referring to FIG. 13, it is shown a graph 1350 indicating the radiation performance of an antenna radiator when a grounding position of each of a plurality of antenna radiators is changed. In the graph 1350, a horizontal axis represents the frequency of the radiated signal (unit: Gigahertz, GHz), and a vertical axis represents the radiation performance (unit: decibel, dB) of the antenna.

The graph 1350 shows a first line 1360 indicating the radiation performance of the first antenna radiator 1311-1 when the ground part of the first antenna radiator 1311-1 is the first ground part 1319-la, a second line 1370 indicating the radiation performance of the first antenna radiator 1311-1 when the ground part of the first antenna radiator 1311-1 is the first ground part 1319-1b, a third line 1380 indicating the radiation performance of the first antenna radiator 1311-2 when the ground part of the first antenna radiator 1311-2 is the second ground part 1319-2a, and a fourth line 1390 indicating the radiation performance of the second antenna radiator 1311-2 when the ground part of the second antenna radiator 1311-2 is the second ground part 1319-2b.

Referring to the first line 1360 and the second line 1370, the resonance frequency of the first line 1360 may be about 1.8 GHZ, 3.5 GHZ, or 5.1 GHZ, and the resonance frequency of the second line 1370 may be about 2.2 GHZ, 4.5 GHZ, or 6.9 GHz. As the position of the first ground part 1319-1 connected to the ground of the first antenna radiator 1311-1 is changed, the resonance frequency of the first antenna radiator 1311-1 may be changed (e.g., up shift). For example, when the position of the first ground part 1319-1 is moved (x) from the first ground part 1319-la to the first ground part 1319-1b, the resonance frequency band of the first antenna radiator 1311-1 may be moved from about 3.5 GHz to about 4.5 GHZ.

Further, referring to the third line 1380 and the fourth line 1390, the resonance frequency of the third line 1380 may be about 1.9 GHZ, 3.5 GHz, or 5.1 GHZ, and the resonance frequency of the fourth line 1390 may be about 2.2 GHZ, 4.5 GHZ, or 6.9 GHZ. As the position of the second ground part 1319-2 connected to the ground of the second antenna radiator 1311-2 is changed, the resonance frequency of the second antenna radiator 1311-2 may be changed (e.g., up shift). For example, when the position of the second ground part 1319-2 is moved (y) from the second ground part 1319-2a to the second ground part 1319-2b, the resonance frequency band of the second antenna radiator 1311-2 may be moved from about 3.5 GHz to about 4.5 GHZ.

As described above, the electronic device 101 may determine a position of the ground part based on a resonance frequency of the antenna radiator. FIG. 13 illustrates an example in which the resonance frequency is up-shifted, but the disclosure is not limited thereto. For example, in a case in which the resonance frequency is up-shifted when the position of the ground part approaches a feeding part, the resonance frequency may be down-shifted when the position of the ground part moves away from the feeding part. For example, the electronic device 101 may change the resonance frequency of the antenna by changing the position of the ground part. Therefore, the electronic device 101 according to an embodiment of the disclosure may communicate with an external electronic device using signals in various bands.

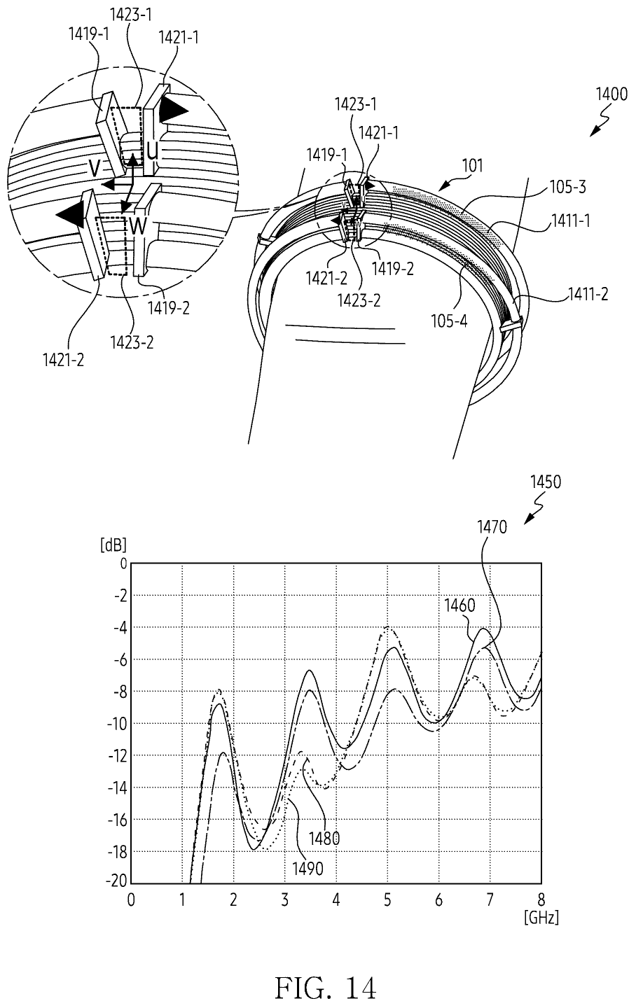

FIG. 14 is a graph illustrating an example of a case in which antenna radiators of an electronic device are formed in an edge area of the electronic device and an example of radiation performance of the antenna radiators according to a state of the antenna radiators, according to an embodiment of the disclosure. The electronic device 101 of FIG. 14 may be understood in substantially the same manner as the electronic device 101 of FIG. 1 and the electronic device 101 of FIG. 2. The electronic device 101 of FIG. 14 includes two antenna radiators only for convenience of description and the disclosure is not limited thereto. For example, the electronic device 101 may include one antenna radiator or three or more antenna radiators. The state of the antenna radiator may indicate that a separated distance between the antenna radiators 1411-1 and 1411-2 is changed, or a separated gap between the feeding part 1421-1 or 1421-2 and the ground part 1419-1 or 1419-2 of the antenna radiator 1411-1 or 1411-2 is changed.

Referring to FIG. 14, an example 1400 is shown in case where the antenna radiators 1411-1 and 1411-2 are formed in an edge area of the electronic device 101. Referring to the example 1400, the electronic device 101 may include a first antenna radiator 1411-1 and a second antenna radiator 1411-2. The electronic device 101 may include a first feeding part 1421-1 for feeding a signal to the first antenna radiator 1411-1 and a second feeding part 1421-2 for feeding a signal to the second antenna radiator 1411-2. The electronic device 101 may include a first ground part 1419-1 for grounding the first antenna radiator 1411-1, and a second ground part 1419-2 for grounding the second antenna radiator 1411-2.

According to an embodiment, the first antenna radiator 1411-1 of the electronic device may be disposed to be spaced apart from the second antenna radiator 1411-2 in a w-axis direction. For example, in the electronic device, the first antenna radiator 1411-1 may be disposed at a maximum distance in the w-axis direction with respect to the second antenna radiator 1411-2. For example, the first antenna radiator 1411-1 may be disposed in one edge area 105-3 of the housing 105 on a layer, and the second antenna radiator 1411-2 of the electronic device 101 may be disposed in another edge area 105-4 opposite to the edge area 105-3 of the housing 105 on the layer.

According to an embodiment, the first antenna radiator 1411-1 of the electronic device 101 may include a first segmented portion 1423-1. For example, the first antenna radiator 1411-1 may be segmented in a region separated between the first ground part 1419-1 and the first feeding part 1421-1. The separated region between the first ground part 1419-1 and the first feeding part 1421-1 may be referred to as a first segmented portion 1423-1. The first ground part 1419-1 may be disposed to be spaced apart from the first feeding part 1421-1 in a v-axis direction. For example, the first segmented portion 1423-1 may extend in the v-axis direction. Further, the second antenna radiator 1411-2 of the electronic device 101 may include a second segmented portion 1423-2. For example, in a region separated between the second ground part 1419-2 and the second feeding part 1421-2, the second antenna radiator 1411-2 may be segmented. The separated region between the second ground part 1419-2 and the second feeding part 1421-2 may be referred to as a second segmented portion 1423-2. The second ground part 1419-2 may be disposed to be spaced apart from the second feeding part 1421-2 in the v-axis direction. For example, the second segmented portion 1423-2 may extend in the v-axis direction.

Referring to FIG. 14, it is shown a graph 1450 illustrating the radiation performance of the antenna when the antenna radiators are spaced apart in the w-axis direction or when the region between the feeding part and the ground part of the antenna radiator is spaced apart in the v-axis direction. In the graph 1450, the horizontal axis represents the frequency of the radiated signal (unit: Gigahertz, GHz), and the vertical axis represents the radiation performance (unit: decibel, dB).

The graph 1450 shows a first line 1460 indicating the radiation performance of the first antenna radiator 1411-1 when a separated distance of the first antenna radiator 1411-1 from the second antenna radiator 1411-2 in the w-axis direction is 5 mm, a second line 1470 indicating the radiation performance of the first antenna radiator 1411-1 when a separated distance of the first antenna radiator 1411-1 from the second antenna radiator 1411-2 in the w-axis direction is 2 mm, and a third line 1480 indicating the radiation performance of the second antenna radiator 1411-2 when a separated distance between the second ground part 1419-2 and the second feeding part 1421-2 in the v-axis direction is 1 mm, and a fourth line 1490 indicating the radiation performance of the second antenna radiator 1411-2 when a separated distance between the second ground part 1419-2 and the second feeding part 1421-2 in the v-axis direction is 0.6 mm.

Referring to the first line 1460 and the second line 1470, the radiation performance of the first antenna radiator 1411-1 may improve as the distance the first antenna radiator 1411-1 is separated from the second antenna radiator 1411-2 increases. In the case of the first line 1460, when the separated distance in the w-axis direction in the frequency band in which the resonance frequency is about 5 GHz is 5 mm, the radiation performance of the first antenna radiator 1411-1 may be about −5 dB. In contrast, in the case of the second line 1470, when the separated distance in the w-axis direction is 2 mm in the frequency band in which the resonance frequency is about 5 GHz, the radiation performance of the first antenna radiator 1411-1 may be about −8 dB. Accordingly, as the distance in which the first antenna radiator 1411-1 is spaced apart from the second antenna radiator 1411-2 is increased, the radiation performance of the first antenna radiator 1411-1 may be improved. In FIG. 14, the example is illustrated with respect to the first antenna radiator 1411-1, but it may be understood substantially the same in the case of the second antenna radiator 1411-2.

Referring to the third line 1480 and the fourth line 1490, in a specific frequency band, as the distance between the second ground part 1419-2 and the second feeding part 1421-2 of the second antenna radiator 1411-1 increases, the radiation performance of the second antenna radiator 1411-2 may increase. In the case of the third line 1480, when the separated distance in the v-axis direction is 1 mm in the frequency band in which the resonance frequency is about 3.5 GHZ, the radiation performance of the second antenna radiator 1411-2 may be about −12 dB. In contrast, in the case of the fourth line 1490, when the separated distance in the v-axis direction is 0.6 mm in the frequency band in which the resonance frequency is about 3.5 GHZ, the radiation performance of the second antenna radiator 1411-2 may be about −13 dB. Accordingly, as the distance in which the second ground part 1419-2 of the second antenna radiator 1411-2 is separated from the second feeding part 1421-2 increases, the radiation performance of the second antenna radiator 1411-2 may be improved. In the case of another frequency band, even if the separated distance in the v-axis direction varies, the radiation performance of the second antenna radiator 1411-2 may be maintained. Although FIG. 14 illustrates on the basis of the second antenna radiator 1411-2, it may be understood substantially the same even in the case of the first antenna radiator 1411-1.

As described above, when the electronic device includes a plurality of antenna radiators, the radiation performance of the antenna radiator may be improved by changing the distance between the antenna radiators in the space formed by the housing of the electronic device. Further, the radiation performance of the antenna radiator for a specific band may be adjusted by changing the separated distance between the feeding part and the ground part of the antenna radiator of the electronic device.

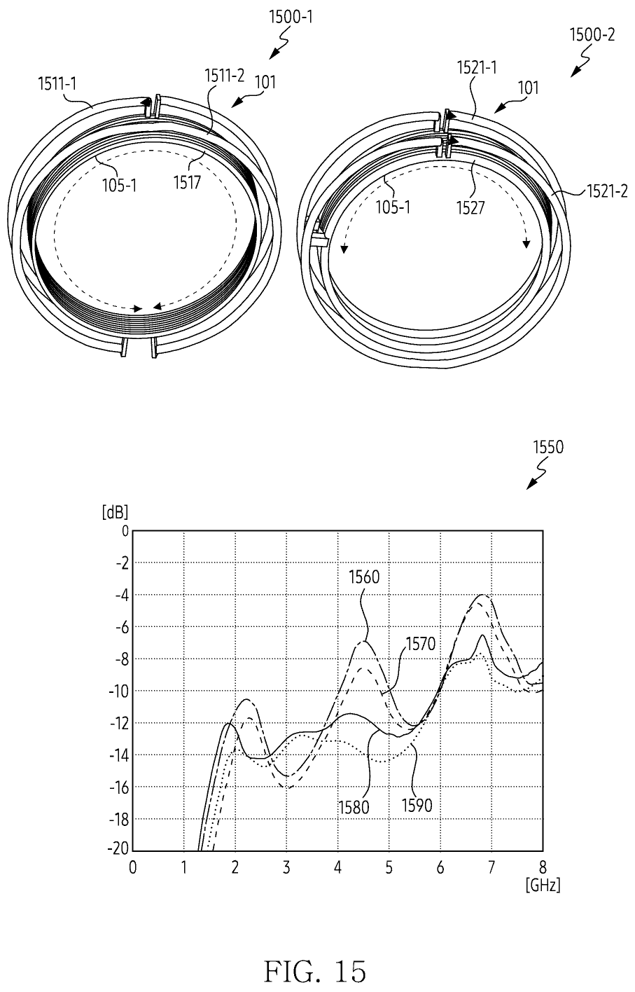

FIG. 15 is a graph illustrating examples of a ground part of an electronic device and an example of radiation performance of an antenna radiator, according to an embodiment of the disclosure. The electronic device 101 of FIG. 15 may be understood to be substantially the same as the electronic device 101 of FIG. 1 and the electronic device 101 of FIG. 2. The electronic device 101 of FIG. 15 includes two antenna radiators, only for convenience of explanation, but the disclosure is not limited thereto. For example, the electronic device 101 may include one antenna radiator or three or more antenna radiators.

Referring to FIG. 15, it is illustrated an example 1500-1 of a case in which the conductor 1517 of the inner surface 105-1 of the electronic device 101 is formed in a full-ring shape and an example 1500-2 of a case in which the conductor 1527 of the inner surface 105-1 is formed in a half-ring shape. Referring to the example 1500-1, the electronic device 101 may include a first antenna radiator 1511-1, a second antenna radiator 1511-2, and a conductor 1517 of a full-ring shape. For example, the conductor 1517 may refer to a portion of the inner surface 105-1 including a conductive portion in a ring shape. In contrast, referring to the example 1500-2, the electronic device 101 may include a first antenna radiator 1521-1, a second antenna radiator 1521-2, and a conductor 1527 of a half-ring shape. The conductor 1527 may refer to a portion of the inner surface 105-1 including a conductive portion in the ring shape. In the example 1500-2, the inner surface 105-1 of the electronic device 101 may include a non-conductive member for an area excepting the conductor 1527. For example, the electronic device 101 of the example 1500-1 may have a wider conductive portion of the inner surface 105-1, which may be located adjacent to the user's body to be coupled, than the electronic device 101 of the example 1500-2.

Referring to FIG. 15, it is shown a graph 1550 indicating the radiation performance of the antenna radiator depending on a shape of the inner surface 105-1 of the electronic device 101. The inner surface 105-1 may refer to a conductive portion that is located adjacent to a user's body and may be coupled to each other or a part of a housing including a conductor. The horizontal axis of the graph 1550 represents the frequency of the radiated signal (unit: Gigahertz, GHz), and the vertical axis represents the radiation performance (unit: decibel, dB) of the antenna. The graph 1550 shows a first line 1560 indicating the radiation performance of the first antenna radiator 1511-1 when the conductor 1517 of the inner surface 105-1 has a full-ring structure, a second line 1570 indicating the radiation performance of the second antenna radiator 1511-2 when the conductor 1517 of the inner surface 105-1 has a full-ring structure, and a third line 1580 indicating the radiation performance of the first antenna radiator 1521-1 when the conductor 1527 of the inner surface 105-1 has a half-ring structure, and a fourth line 1590 indicating the radiation performance of the second antenna radiator 1521-2 when the conductor 1527 of the inner surface 105-1 has a half-ring structure.

When comparing the first line 1560 and the third line 1580, the radiation performance of the first antenna radiator 1511-1 and the radiation performance of the first antenna radiator 1521-1 may be adjusted according to the frequency band of the resonance frequency. For example, in a band of about 2 GHZ, the value of the first line 1560 may be about −10.5 dB, but the value of the third line 1580 may be about −12 dB. Further, in a band of about 4.5 GHZ, the value of the first line 1560 may be about −7 dB, but the value of the third line 1580 may be about −11.5 dB. Furthermore, in a band of about 6.8 GHZ, the value of the first line 1560 may be about −4 dB, but the value of the third line 1580 may be about −6.8 dB. In specific frequency bands (e.g., approximately 2 GHz, 4.5 GHZ, 6.8 GHZ), the radiation performance of the first antenna radiator 1511-1 of the electronic device 101 including a full-ring-shaped conductor may be greater than that of the first antenna radiator 1511-1 of the electronic device 101 including a half-ring-shaped conductor. Furthermore, in a band of about 3 GHZ, the value of the first line 1560 may be about −15 dB, but the value of the third line 1580 may be about-13 dB. In a specific frequency band (e.g., about 3 GHZ), the radiation performance of the first antenna radiator 1511-1 of the electronic device 101 including a half-ring-shaped conductor may be greater than that of the first antenna radiator 1511-1 of the electronic device 101 including a full-ring-shaped conductor.

Comparing the second line 1570 with the fourth line 1590, the radiation performance of the second antenna radiator 1511-2 and the radiation performance of the second antenna radiator 1521-2 may be adjusted according to the frequency band at the resonance frequency. For example, in a band of about 2 GHZ, the value of the second line 1570 may be about −11.9 dB, but the value of the fourth line 1590 may be about −13.8 dB. Further, in a band of about 4.2 GHZ, the value of the second line 1570 may be about −9 dB, but the value of the fourth line 1590 may be about −13 dB. Further, in a band of about 6.8 GHZ, the value of the second line 1570 may be about −4.7 dB, but the value of the fourth line 1590 may be about −7.8 dB. In the specific frequency bands (e.g., approximately 2 GHz, 4.5 GHZ, 6.8 GHZ), the radiation performance of the second antenna radiator 1511-2 of the electronic device 101 including a fully ring-shaped conductor may be greater than that of the second antenna radiator 1511-2 of the electronic device 101 including a half-ring-shaped conductor. Further, in a band of about 3 GHZ, the value of the second line 1570 may be about −16 dB, but the value of the fourth line 1590 may be about −13 dB. In a specific frequency band (e.g., about 3 GHz), the radiation performance of the second antenna radiator 1511-2 of the electronic device 101 including a half-ring-shaped conductor may be greater than that of the second antenna radiator 1511-2 of the electronic device 101 including a full-ring-shaped conductor.

Referring to the above description, as the area of a conductive member (e.g., a conductor) included in the inner surface of the electronic device is changed, the frequency band in which the radiation performance of the antenna radiator is improved may be changed. Therefore, the area of the conductive member included in the inner surface may be designed in consideration of the frequency band supported by the electronic device.

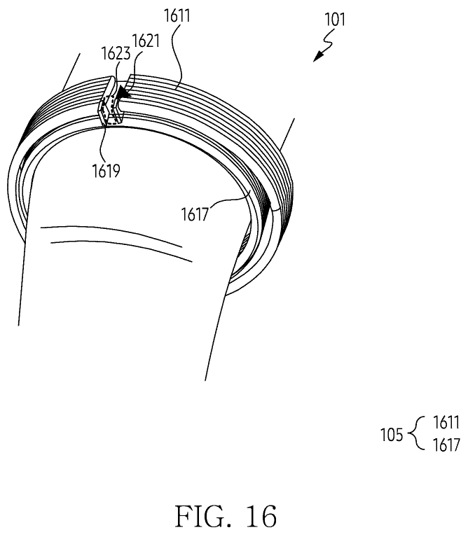

FIG. 16 illustrates an example of an outer surface of an electronic device that is used as an antenna radiator according to an embodiment of the disclosure. The electronic device 101 of FIG. 16 may be understood in the same manner as the electronic device 101 of FIG. 1 and the electronic device 101 of FIG. 2. The outer surface may refer to a part of a ring-shaped housing of the electronic device 101. The outer surface is a part that is exposed to the outside while being worn by the user, and may refer to a surface that faces a direction opposite to the direction in which the inner surface that is not exposed by being in contact with the user's body faces.

According to an embodiment, the electronic device 101 may include an outer surface 1611, an inner surface 1617, and a coupling member 1619 connecting the outer surface 1611 and the inner surface 1617 to each other. For example, the outer surface 1611 and the inner surface 1617 may be included in the housing 105 of the electronic device 101.

According to an embodiment, the outer surface 1611 of the electronic device 101 may be a radiator for radiating a signal fed from a wireless communication circuit. For example, the outer surface 1611 may be formed like an antenna of the first example 701 of FIG. 7A. Referring to FIG. 9, the outer surface 1611 may be formed of various materials. However, as the electronic device 101 of FIG. 16 uses the outer surface 1611 as an antenna radiator, the outer surface 1611 may include a conductive member. For example, the electronic device 101 of FIG. 16 may be understood to be substantially the same as the first example 910 of FIG. 9. However, the disclosure is not limited thereto, and even when the outer surface 1611 is used as a radiator, only a part of the outer surface 1611 may include a conductive member, and a remaining part thereof may include a non-conductive member.

According to one embodiment, the inner surface 1617 may be formed in a full-ring shape. The inner surface 1617 may include a conductive portion (or conductor) that is in contact with the user's body, when the user wears the electronic device 101. Referring to FIG. 10, the inner surface 1617 may be formed in various shapes. For example, the electronic device 101 of FIG. 16 may include an O-shaped inner surface as in the first case 1010. However, the disclosure is not limited thereto, and the electronic device 101 of the disclosure may include a structure of the inner surface 1617 of various shapes.

According to an embodiment, the outer surface 1611 of the electronic device 101 may include a segmented portion 1623. For example, the outer surface 1611 may include a segmented portion 1623 between a coupling member 1621 which is a feeding part and a coupling member 1619 which is a ground part. The coupling member 1619 may have a structure for connecting the antenna radiator (e.g., the outer surface 1611 in the case of FIG. 16) of the electronic device 101 with a conductor (e.g., the inner surface 1617 in the case of FIG. 16) which is in contact with the body acting as a ground for the antenna radiator. The conductor may be included in the inner surface 1617.

As described above, the electronic device 101 of FIG. 16 does not include a separate radiator, and may use the outer surface 1611 forming the housing 105 as a radiator. Accordingly, the electronic device 101 may use the inner space of the housing 105 more efficiently. For example, as a space required to dispose the antenna radiator is not necessary, the electronic device 101 may include other components or may be formed in a more miniaturized structure.

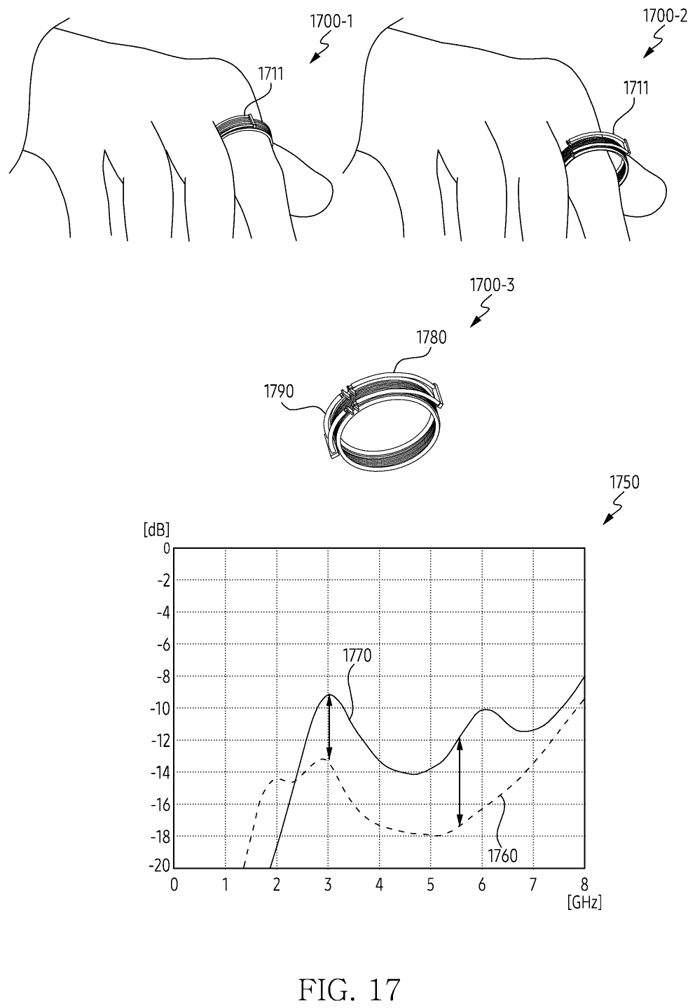

FIG. 17 is a graph illustrating an example of an electronic device that radiates a signal by changing an antenna radiator according to an external environment, and an example of radiation performance of the antenna radiator, according to an embodiment of the disclosure. The electronic device of FIG. 17 may be understood to be substantially the same as the electronic device 101 of FIG. 1 and the electronic device 101 of FIG. 2. The electronic device of FIG. 17 includes one antenna radiator, but the disclosure is not limited thereto. For example, the electronic device may include two or more antenna radiators and may select one of the antenna radiators in consideration of the radiation performance.

Referring to FIG. 17, it is shown an example 1700-1 of a case in which the antenna is positioned close to an adjacent body (e.g., a finger), when the electronic device is worn by the user, and an example 1700-2 of a case in which the antenna is positioned far from an adjacent body. Referring to the example 1700-1, the electronic device may include an antenna radiator 1711 and a position of the antenna radiator 1711 may be located close to another finger adjacent to a finger wearing the electronic device. In contrast, referring to the example 1700-2, the electronic device may include an antenna radiator 1711 and a position of the antenna radiator 1711 may be located far from another finger adjacent to the finger wearing the electronic device.

Referring to FIG. 17, it is shown a graph 1750 indicating the radiation performance of the antenna radiator according to a distance of the antenna radiator to an adjacent body (e.g., a finger). In the graph 1750, the horizontal axis represents the frequency of the radiated signal (unit: Gigahertz, GHz), and the vertical axis represents the radiation performance (unit: decibel, dB) of the antenna radiator. The graph 1750 shows a first line 1760 indicating the radiation performance of the antenna radiator 1711 when the antenna is located close to an adjacent body (e.g., a finger), and a second line 1770 indicating the radiation performance of the antenna radiator 1711 when the antenna is located far from an adjacent body.

Comparing the first line 1760 with the second line 1770, when the antenna radiator 1711 is located far from an adjacent body, interference of the body with respect to the antenna radiator 1711 may be reduced, and the radiation performance of the antenna radiator 1711 may be secured. For example, in a 3 GHz band, the value of the first line 1760 may be about −13.5 dB, but the value of the second line 1770 may be about −9 dB. Further, in a 5.5 GHz band, the value of the first line 1760 may be about −17 dB, but the value of the second line 1770 may be about −12 dB. As described above, as the radiator (e.g., the antenna radiator 1711) of the electronic device 101 is farther from the adjacent body, the radiation performance of the antenna may be improved.

The example 1700-1 and the example 1700-2 of FIG. 17 illustrate the electronic device including one antenna radiator for convenience of description, but the disclosure is not limited thereto. Referring to an example 1700-3, when the electronic device includes a plurality of antenna radiators 1780 and 1790, the electronic device may identify a position of an adjacent body other than the currently worn body using a sensor (e.g., a grip sensor) and the like, and may select an antenna radiator located far from the adjacent body. Alternatively, the electronic device may select an antenna radiator having better radiation performance from among the antenna radiators 1780 and 1790, based on a strength of the received signal (e.g., reference signal received power, RSRP). Alternatively, the electronic device may select an antenna radiator from among the antenna radiators 1780 and 1790, based on an impedance changed by the adjacent body. Accordingly, the electronic device may communicate with an external electronic device through the identified antenna radiator. In this case, the electronic device may identify information acquired through the sensor or the like through an internal processor and select the antenna radiator.

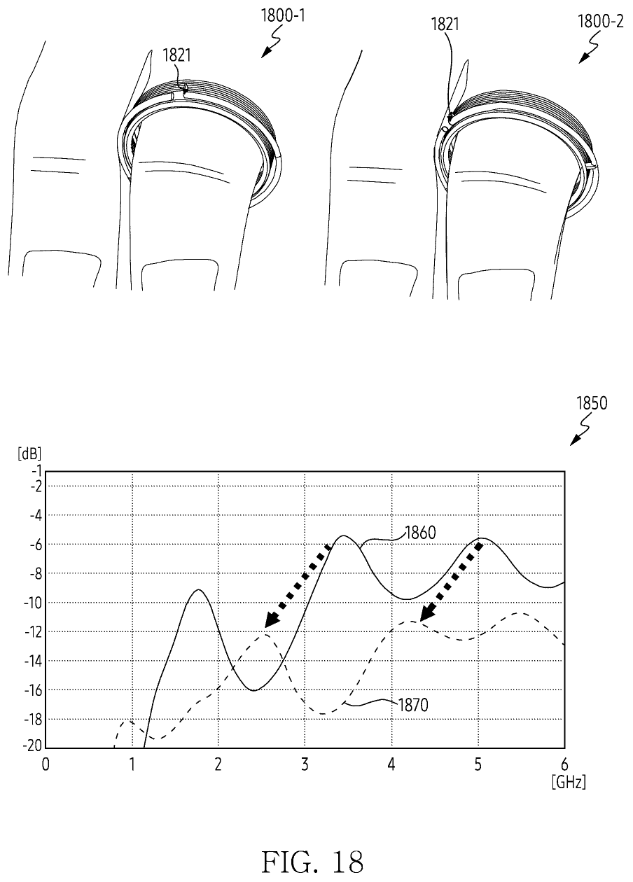

FIG. 18 is a graph illustrating examples of a position of a ground part of an electronic device and an example of radiation performance of an antenna radiator, according to an embodiment of the disclosure. The electronic device of FIG. 18 may be understood to be substantially the same as the electronic device 101 of FIG. 1 and the electronic device 101 of FIG. 2. The electronic device of FIG. 17 includes one antenna radiator for convenience of description, but the disclosure is not limited thereto. For example, the electronic device may include two or more antenna radiators and may select one of the antenna radiators in consideration of radiation performance.

Referring to FIG. 18, when the electronic device is worn by the user, it is shown an example 1800-1 of a case in which a position of a feeding part is located far from an adjacent body (e.g., a finger) is illustrated, and an example 1800-2 of a case in which the position of the feeding part is located close to the adjacent body. For example, the position far from the adjacent body may refer to a direction (upward) in which the back of the hand faces on the basis of the finger wearing the electronic device. Further, the position close to the adjacent body may refer to a lateral direction toward the adjacent body. Referring to the example 1800-1, the electronic device may include an antenna radiator, and the position of the feeding part 1821 for the antenna radiator may be located far from another finger adjacent to the finger wearing the electronic device. In contrast, referring to the example 1800-2, the electronic device may include an antenna radiator, and the position of the feeding part 1821 for the antenna radiator may be located close to another finger adjacent to the finger wearing the electronic device.

Referring to FIG. 18, a graph 1850 indicating the radiation performance of the antenna radiator according to a distance of the feeder part from the adjacent body (e.g., finger) is illustrated. The horizontal axis of the graph 1850 represents the frequency of the radiated signal (unit: Gigahertz, GHz), and the vertical axis represents the radiation performance (unit: decibel, dB) of the antenna radiator. The graph 1850 shows a first line 1860 indicating the radiation performance of the antenna radiator when the feeding part is located far from the adjacent body (e.g., finger) (e.g., the upper end) and a second line 1870 indicating the radiation performance of the antenna radiator when the feeding part is located close to the adjacent body (e.g., the side facing the adjacent body).

Comparing the first line 1860 with the second line 1870, when the feeding part for the antenna radiator is located far from the adjacent body, the radiation performance of the antenna radiator may be improved. In the first line 1860, the resonance frequency may be about 1.8 GHZ, 3.5 GHZ, and 5 GHZ, respectively. At each resonance frequency, the values of the first line 1860 representing the radiation performance may be about −9.2 dB, −5.5 dB, and −5.8 dB. In contrast, in the second line 1870, the resonance frequency may be about 0.9 GHZ, 2.5 GHZ, and 4.2 GHz. At each resonance frequency, the values of the second line 1870 representing the radiation performance may be about −18 dB, −12.2 dB, and −11.5 dB.

According to the above description, the radiation performance of the antenna radiator may be improved as the feeding part for the radiator (e.g., antenna) of the electronic device 101 is located farther from an adjacent body (e.g., an upper end or a side surface facing an opposite direction of an adjacent finger). In contrast, when the feeding part is located on a part where a finger is folded (e.g., a lower end) or a side facing the adjacent finger, the radiation performance of the antenna may be deteriorated. Although FIG. 18 illustrates the electronic device including one antenna radiator for convenience of description, the disclosure is not limited thereto. When the electronic device includes a plurality of antenna radiators, the electronic device may identify the position of an adjacent body other than the currently worn body using a sensor (e.g., a grip sensor) or the like, and may select a feeding part and an antenna radiator positioned far from the adjacent body. Accordingly, the electronic device may communicate with an external electronic device through the identified antenna radiator. In this case, the electronic device may identify information obtained through a sensor or the like using an internal processor, and may select a feeding part and an antenna radiator.

In FIG. 18, the feeding part is described as an example, but the same may be applied to the segmented portions and the spaced apart areas between the antenna radiators. The segmented portion may include a portion in which the conductive portion of the antenna radiator is not continuous and arranged to be spaced apart from each other. The spaced apart area may refer to a separated portion between the antenna radiators. For example, in the first example 701 of FIG. 7A, the antenna radiator 711 may include a segmented portion in which a conductive portion is not continuous and is spaced apart from each other. Further, in the fourth example 717 of FIG. 7A, the first antenna radiator 718 may include a segmented portion 722-1 in which a conductive portion is not continuous and is spaced apart from each other. Further, in the fourth example 717 of FIG. 7A, separated areas 723-1 and 723-2 between the first antenna radiator 718 and the second antenna radiator 719 may be formed. According to an embodiment, the segmented portion or the separated area may be disposed to be located far from an adjacent body (e.g., finger) when the user wears the electronic device. For example, a position far from the adjacent body may refer to a direction (upward) in which the back of the hand faces on the basis of the finger on which the electronic device is worn. For example, the segmented portion or the separated area may be arranged to avoid being located on the side facing the adjacent body or at the lower end that is shielded when the finger is folded.

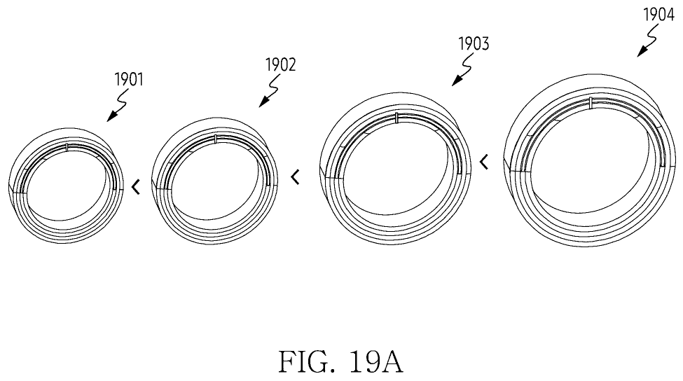

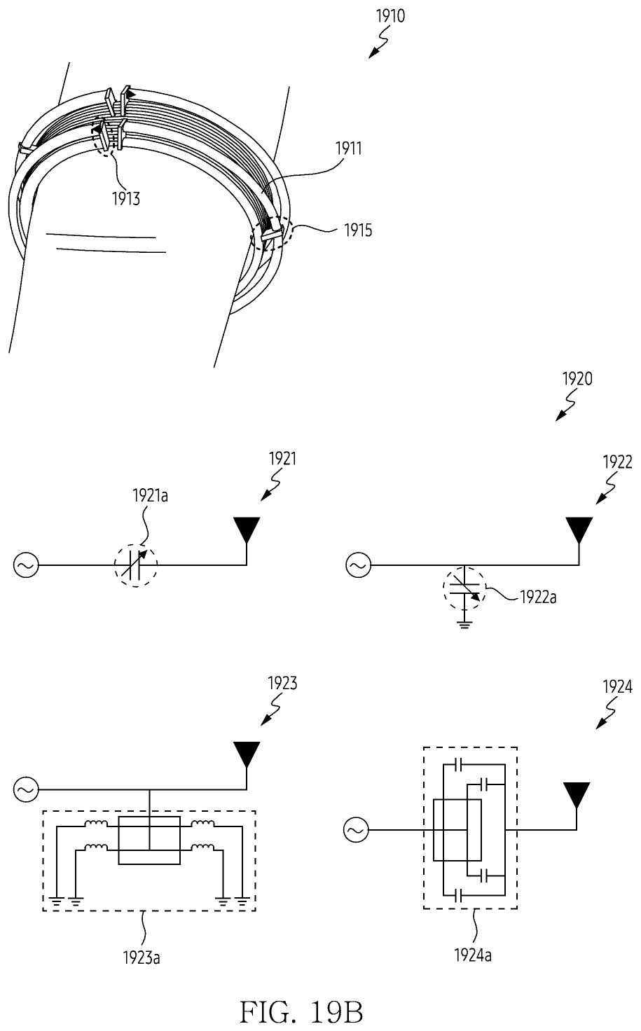

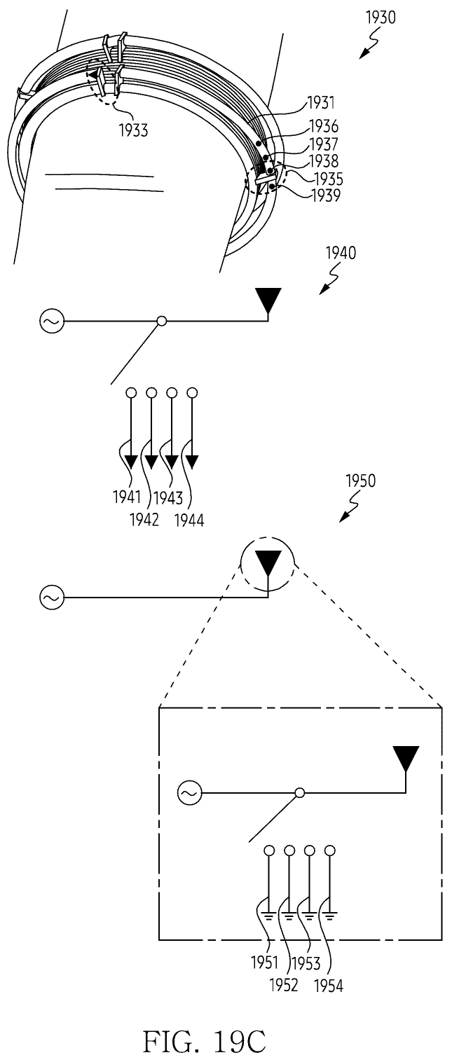

FIG. 19A illustrates examples of electronic devices of various sizes according to an embodiment of the disclosure. FIG. 19B illustrates examples of a tuning structure of a feeding part for electronic devices of various sizes according to an embodiment of the disclosure. FIG. 19C illustrates examples of a tuning structure of a ground part for electronic devices of various sizes according to an embodiment of the disclosure. The electronic devices of FIGS. 19A to 19C may be understood in the same manner as the electronic device 101 of FIG. 1 and the electronic device 101 of FIG. 2. The tuning structure may refer to a structure for changing the electrical characteristics.

Referring to FIG. 19A, the electronic device may be formed in various sizes. For example, the electronic device may have a larger size in the order of a first example 1901, a second example 1902, a third example 1903, and a fourth example 1904. For example, in the first example 1901, the size of the electronic device may increase as it goes from the first example 1901, to the second example 1902, the third example 1903, and the fourth example 1904. In consideration of diversity in the size (or circumference) of the user's finger wearing the electronic device, the electronic device may be formed in various sizes. For example, the electronic device for a ring finger among the fingers of the user has to be formed in a size smaller than that of the electronic device for a middle finger or an index finger. Accordingly, the electronic device for the ring finger may be as in the first example 1901. Further, since the size of the finger may vary for each user, the electronic device may be formed in various sizes. As described above, the physical size of the electronic device may vary according to the size of the user's finger. However, even if the physical size of the electronic device is changed, the electrical size of the antenna radiator of the electronic device needs to be the same. This is because when the physical size of the antenna radiator increases in proportion to the physical size of the electronic device, the resonance frequency of the signal or the characteristic of the signal may be changed even when the same signal is fed. Therefore, even if the physical size of the antenna radiator increases, a structure for the electronic device to radiate a signal through substantially the same antenna radiator may be required.

Referring to FIG. 19B, an example 1910 for an electronic device including a feeding part and a ground part and an example 1920 for structures of the feeding part and the ground part are illustrated. The feeding part may include a coupling member for feeding a signal to the antenna radiator from a wireless communication circuit. The ground part may include a coupling member for connecting the antenna and the ground. Referring to the example 1910, the electronic device may include a feeding part 1913 for feeding power to the antenna radiator 1911 and a ground part 1915 for connecting the antenna radiator 1911 to the ground. According to an embodiment, the feeding part 1913 may include a structure for changing the electrical characteristics of the antenna radiator 1911. For example, the ground part 1915 may include a structure for changing the electrical characteristics of the antenna radiator 1911. The structure for changing the electrical characteristics may be referred to as a tuning structure.

Referring to the example 1920, the feeding part or the ground part of the first case 1921 may include a variable capacitor 1921a connected in series. For example, the feeding part or the ground part of the second case 1922 may include a variable capacitor 1922a connected in parallel. For example, the feeding part or the ground part of the third case 1923 may include a switch 1923a connected in parallel. For example, the feeding part or the ground part of the fourth case 1924 may include a switch 1924a connected in series. Referring to the above description, the feeding part or the ground part may change the electrical characteristics of the antenna radiator through a variable capacitor or a switch. As the size of the electronic device increases, the electrical characteristics of the antenna may be maintained by means of the variable capacitor or the switch of the feeding part or the ground part, even if the physical size of the antenna radiator increases.

Referring to FIG. 19C, an example 1930 of an electronic device including a ground part and examples 1940 and 1950 of a structure for changing a position at which the ground part is connected to the antenna radiator are illustrated. The feeding part may include a coupling member for feeding a signal to the antenna radiator from a wireless communication circuit. The ground part may include a coupling member for connecting the antenna radiator and the ground.

Referring to the example 1930, the electronic device may include a feeding part 1933 for feeding power to the antenna radiator 1931, and a ground part 1935 for connecting the antenna radiator 1931 to the ground. According to an embodiment, in order to change the electrical characteristics of the antenna radiator 1931, a position of the ground part 1935 connected to the antenna radiator 1931 may be changed. The structure for changing the electrical characteristics may be referred to as a tuning structure. Referring to the example 1940, the ground part may change a ground contact position of the PCB. For example, the ground contact position inside the PCB (not shown) may include a first position 1941, a second position 1942, a third position 1943, and a fourth position 1944 and may be changed thereto, respectively. By changing the electrical position (e.g., the first position 1941, the second position 1942, the third position 1943, or the fourth position 1944) connected to the internal ground of the PCB, the electrical characteristics of the antenna radiator may be changed. Further, referring to the example 1950, the ground part may change a ground contact position of the antenna radiator. For example, as the position at which the ground part 1935 is connected to the antenna radiator 1931 is changed to a first position 1936, a second position 1937, a third position 1938, and a fourth position 1939, the ground contact position of the antenna radiator may be changed to the first position 1951, the second position 1952, the third position 1953, and the fourth position 1954, respectively. Referring to the above description, the ground part may change then electrical characteristic of the antenna radiator, as the position at which the ground part is connected to the antenna is changed. As a size of the electronic device increases, even if a physical size of the antenna radiator increases, the position at which the ground part is connected to the antenna radiator may be changed, so that the electrical characteristic of the antenna radiator may be maintained.

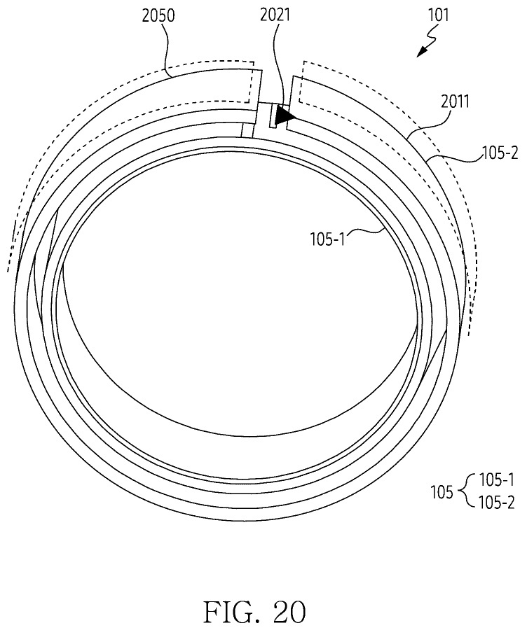

FIG. 20 illustrates an example of an electronic device including a display according to an embodiment of the disclosure. The electronic device 101 of FIG. 20 may be an example of the electronic device 101 of FIG. 1 and the electronic device 101 of FIG. 2.

Referring to FIG. 20, the electronic device 101 may be formed in a ring shape. For example, the housing 105 of the electronic device 101 may be formed in a ring shape that may be worn on a user's finger. In FIGS. 19A to 19C, a ring-shaped electronic device 101 having a smooth surface is illustrated as an example, but the disclosure is not limited thereto. For example, the electronic device 101 may be formed as a housing 105 including a plurality of planes. For example, the ring-shaped electronic device 101 having a non-smooth surface may also be understood as an embodiment of the disclosure.

Referring to FIG. 20, according to an embodiment, the electronic device 101 may include a housing 105, an antenna radiator 2011, a coupling member 2021 for feeding power to the antenna radiator 2011, and a display 2050.

According to an embodiment, the outer surface 105-2 of the housing 105 may include a display 2050. For example, the display 2050 may be mounted (e.g., by surface mounted technology, SMT) along a surface of the outer surface 105-2 of the housing 105. Alternatively, the display 2050 may be mounted such that it extends from a space between the outer surface 105-2 and the inner surface 105-1 of the housing 105 to be exposed to the outside. For example, the display 2050 may be disposed in an area including at least one layer and the outer surface 105-2 of the housing 105.

According to an embodiment, the display 2050 may be disposed not to overlap the antenna radiator 2011 and the feeding part (i.e., coupling member 2021). This is because the display 2050 includes a structure (e.g., light emitting diode (LED) for displaying an image to the outside and thus may interfere with the radiation of the antenna radiator 2011.

According to the above description, the display 2050 is disposed in an area similar to an area in which the antenna radiator 2011 is mounted (e.g., the outer surface 105-2, a layer in the housing 105, etc.), and thus an area in which the antenna radiator 2011 is disposed may be limited. For example, the antenna radiator 2011 and the feeding part (i.e., coupling member 2021) may be mounted on the electronic device 101 so as to avoid the position of the display 2050. This may be to improve the radiation performance of the antenna radiator 2011 by minimizing interference of the radiation of the antenna radiator 2011 by the display 2050.

Referring to FIGS. 1, 2, 3A, 3B, 4, 5A, 5B, 5C, 6A, 6B, 7A, 7B, 8 to 18, 19A, 19B, 19C, and 20, the antenna radiator structure of the disclosure and the electronic device including the same can improve the radiation performance of the antenna radiator even in its miniaturized structure. When worn by a user, the electronic device can expand the ground area by using the user's body as a ground for the antenna radiator. As the ground area is expanded, the radiation performance of the antenna radiator of the electronic device may be improved. Furthermore, the antenna radiator structure of the disclosure and the electronic device including the same may be applied to antenna radiators of various structures. In consideration of the components mounted in an electronic device, the size of the electronic device, and the radiation performance of the antenna radiator, the antenna radiator structure of the disclosure and the electronic device including the same may include antenna radiators having various shapes or structures. As described above, the antenna radiator structure of the disclosure and the electronic device including the same may communicate with an external device at a more distant distance by improving the radiation performance of the antenna radiator in an electronic device having a miniaturized structure, without having to interwork with other devices through a wired line.

A wearable device 101, as described above, may include a housing 105 with a ring-shape, including an inner surface and an outer surface. The wearable device 101 may include a first layer between the inner surface and the outer surface of the housing 105, including a printed circuit board (PCB) 113. The wearable device 101 may include a second layer between the outer surface and the first layer, including a conductive portion 111. The wearable device 101 may include at least one circuit for wireless communication, attached to the PCB 113. The wearable device 101 may include another conductive portion 117 formed in a portion of the inner surface. The wearable device 101 may include a first coupling member 119 for electrically connecting the conductive portion 111 and the another conductive portion 117. The wearable device 101 may include a second coupling member for electrically connecting the conductive portion 111 and the at least one circuit. The at least one circuit may be configured to communicate with an external electronic device by using the conductive portion 111 obtaining a signal fed from the at least one circuit and the another conductive portion 117 coupled to a ground.

According to an embodiment, the conductive portions 111 and 711 may extend from a first portion, spaced apart from the another conductive portion 117, coupled to the second coupling member, along the outer surface of the housing 105 in the ring-shape. A width of the conductive portion 111 and 711 may correspond to a width of the outer surface.

According to an embodiment, the conductive portion 111 may include a first conductive portion 713-1 and a second conductive portion 713-2. The first conductive portion 713-1 may include a first edge, extending along the housing 105 in a first direction, from a first portion spaced apart from the another conductive portion 117 and coupled to the second coupling member. The first conductive portion 713-1 may include a second edge, extending from the first edge and extending along the housing 105 in a second direction perpendicular to the first direction. The first conductive portion 713-1 may include a third edge, extending from the second edge and extending along the housing 105 in a third direction perpendicular to the second direction and opposite to the first direction. The first conductive portion 713-1 may include a fourth edge, extending from the third edge and extending along the housing 105 in a fourth direction perpendicular to the third direction and opposite to the second direction. The first conductive portion 713-1 may include a fifth edge, extending from the fourth edge, extending along the housing 105 in the first direction, and coupled to the first coupling member. The first edge may be disposed spaced apart from the fifth edge.

According to an embodiment, the conductive portion 111 and 715-1 may include an edge extending along the housing 105 in the ring-shape from a first portion coupled to the second coupling member, spaced apart from the another conductive portion 117. A width of the edge may be narrower than a width of the outer surface.

According to an embodiment, the conductive portions 111, 715-1 and 715-2 may further include another edge extending along the housing 105 in the ring-shape from a second portion, spaced apart from the another conductive portion 117, coupled to a fourth coupling member different from the second coupling member. The another edge may be electrically connected to the at least one circuit via a third coupling member different from the second coupling member. A width of the another edge may correspond to a width of the edge. The another edge may be disposed spaced apart from the edge.

According to an embodiment, the conductive portions 111 and 717 may be disposed spaced apart from the another conductive portion 117. The conductive portions 111 and 717 may include a first edge extending along the housing 105 in a first direction from a first portion coupled to the second coupling member. The conductive portions 111 and 717 may include a second edge extending along the housing 105 in a second direction perpendicular to the first direction from the first edge. The conductive portions 111 and 717 may include a third edge extending along the housing 105 in a third direction perpendicular to the second direction and opposite to the first direction from the second edge. The third edge may be coupled to the first connecting member.

According to an embodiment, the conductive portions 111 and 719) may be disposed spaced apart from the another conductive portion 117. The conductive portions 111 and 719 may include a fourth edge extending along the housing 105 in the third direction and extending from the third edge from a portion where the first coupling member and the third edge are coupled. The conductive portions 111 and 719 may include a fifth edge extending along the housing 105 in the second direction and extending from the fourth edge. The conductive portions 111 and 719 may include a sixth edge extending along the housing 105 in the first direction and extending from the fifth edge. The six edge may be disposed spaced apart from the first edge.

According to an embodiment, the conductive portion 111 may include a first portion 741, a second portion 742, and a third portion 743. The first portion 741 may be an edge extending along the housing 105 in the ring-shape from a first point coupled to the second coupling member, spaced apart from the another conductive portion. The second portion 742 may be an edge extending along the housing 105 in the ring-shape from a second point different from the first point, spaced apart from the another conductive portion, coupled to the second coupling member. The third portion 743) may be spaced apart from each of the first portion 741 and the second portion 742, and may extend along the housing 105 in the ring-shape from a third point different from the first point and the second point, spaced apart from the another conductive portion, coupled to the second coupling member. A width of the third portion 743 may be wider than a width of the first portion 741 and a width of the second portion 742, and may be narrower than a width of the outer surface.

According to an embodiment, the outer surface of the housing 105 may be configured as one of a conductive member, a non-conductive member, or a combination of a conductive member and a non-conductive member.

According to an embodiment, the inner surface of the housing 105 including the another conductive member may be formed as another ring-shape smaller than the ring-shape of the housing 105. Alternately, the inner surface may include a plurality of portions configuring the another ring shape of the housing 105 and may be formed so that each of the plurality of portions is segmented at a specified distance from each other. Alternately, the inner surface may be formed to correspond to a portion of the small ring-shape of the housing 105.

According to an embodiment, the wearable device 101 may further include a third coupling member different from the first coupling member. The third coupling member may electrically connects the conductive portion and the another conductive portion at a position different from the first coupling member.

According to an embodiment, the first coupling member 119 may include a coupling structure based on at least one from among a soldering, a coupling, or a connector. The second coupling member may include a coupling structure based on a soldering.

According to an embodiment, the first coupling member 119 may be configured as a variable capacitor or a switch. Alternately, the first coupling member 119 may be configured to be capable of changing a position where the conductive portion and the another conductive portion are coupled. The second coupling member may be configured as a variable capacitor or a switch.

According to an embodiment, the wearable device 101 may further include a display. The display may be formed in a first region of the outer surface corresponding to the conductive portion and a third region of the outer surface different from a second region of the outer corresponding to the second member.

According to an embodiment, the wearable device may further include a battery. The battery may be mounted across the first layer and the second layer.

A wearable device 101, as described above, may include a housing 405 with a ring-shape, including an inner surface and an outer surface. The wearable device 101 may include a layer between the inner surface and the outer surface of the housing 405, including a printed circuit board (PCB) 413 and a conductive portion 411. The wearable device 101 may include at least one circuit for wireless communication attached to the PCB 413. The wearable device may include another conductive portion 417 formed in a portion of the inner surface. The wearable device 101 may include a third coupling member 423 for electrically connecting the PCB 413 and the another conductive portion 417. The wearable device 101 may include a fourth coupling member 421 for electrically connecting the conductive portion 411 and the at least one circuit. The at least one circuit may be configured to communicate with an external electronic device, using the conductive portion 411 obtaining a signal fed from the at least one circuit and the another conductive portion 417 coupled to a ground.

According to an embodiment, the conductive portion 411 may extend from a first portion, spaced apart from the another conductive portion 417, coupled to the fourth coupling member 421, along the outer surface of the housing 105 in the ring-shape. A width of the conductive portion 411 may correspond to a width of the outer surface.

According to an embodiment, the conductive portion 411 may include a first conductive portion 713-1 and a second conductive portion 713-2. The first conductive portion 713-1 may include a first edge, extending along the housing 105 in a first direction, from a first portion, spaced apart from the another conductive portion 117, coupled to the second coupling member. The first conductive portion 713-1 may include a second edge, extending from the first edge and extending along the housing 105 in a second direction perpendicular to the first direction. The first conductive portion 713-1 may include a third edge, extending from the second edge and extending along the housing 105 in a third direction perpendicular to the second direction and opposite to the first direction. The first conductive portion 713-1 may include a fourth edge, extending from the third edge and extending along the housing 105 in a fourth direction perpendicular to the third direction and opposite to the second direction. The first conductive portion 713-1 may include a fifth edge, extending from the fourth edge, extending along the housing 105 in the first direction, and coupled to the first coupling member. The first edge may be disposed spaced apart from the fifth edge.

According to an embodiment, the conductive portions 411 and 715-1 may include an edge extending along the housing 105 in the ring-shape from a first portion coupled to the fourth coupling member 421, spaced apart from the another conductive portion 417. A width of the edge may be narrower than a width of the outer surface.

According to an embodiment, the conductive portions 411 and 717 may be disposed spaced apart from the another conductive portion 417. The conductive portions 411 and 717 may include a first edge extending along the housing 105 in a first direction from a first portion coupled to the second coupling member 421. The conductive portions 411 and 717 may include a second edge extending along the housing 105 in a second direction perpendicular to the first direction from the first edge. The conductive portions 411 and 717 may include a third edge extending along the housing 105 in a third direction perpendicular to the second direction and opposite to the first direction from the second edge. In the conductive portions 411 and 717, the third edge may be coupled to the first connecting member 423.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. The electronic devices according to an embodiment of the disclosure are not limited to those described above.

It should be appreciated that various embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled to/with”, or “connected to/with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may be interchangeably used with other terms, for example, “logic,” “logic block,”, “unit”, “part,”, “portion” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable device comprising:
a housing with a ring-shape including an inner surface and an outer surface;
a first layer between the inner surface and the outer surface of the housing, including a printed circuit board (PCB);
a second layer between the outer surface and the first layer, including a conductive portion;
at least one circuit for wireless communication attached to the PCB;
another conductive portion formed in a portion of the inner surface;
a first coupling member for electrically connecting the conductive portion and the another conductive portion; and
a second coupling member for electrically connecting the conductive portion and the at least one circuit,
wherein the at least one circuit is configured to communicate with an external electronic device by using the conductive portion obtaining a signal fed from the at least one circuit and the another conductive portion coupled to a ground.

2. The wearable device of claim 1,
wherein the conductive portion extends from a first portion, spaced apart from the another conductive portion, coupled to the second coupling member along the outer surface of the housing as the ring-shape, and
wherein a width of the conductive portion corresponds to a width of the outer surface.

3. The wearable device of claim 1,
wherein the conductive portion includes a first conductive portion and a second conductive portion,
wherein the first conductive portion includes:
a first edge, extending along the housing in a first direction, from a first portion, spaced apart from the another conductive portion, coupled to the second coupling member,
a second edge, extending from the first edge, extending along the housing in a second direction perpendicular to the first direction,
a third edge, extending from the second edge, extending along the housing in a third direction perpendicular to the second direction and opposite to the first direction,
a fourth edge, extending from the third edge, extending along the housing in a fourth direction perpendicular to the third direction and opposite to the second direction, and
a fifth edge, extending from the fourth edge, extending along the housing in the first direction, and coupled to the first coupling member, and wherein the first edge is disposed spaced apart from the fifth edge.

4. The wearable device of claim 1,
wherein the conductive portion includes an edge extending along the housing as the ring-shape from a first portion, spaced apart from the another conductive portion, coupled to the second coupling member, and
wherein a width of the conductive portion is narrower than a width of the outer surface.

5. The wearable device of claim 4,
wherein the conductive portion further includes another edge extending along the housing as the ring-shape from a second portion, spaced apart from the another conductive portion, coupled to a fourth coupling member different from the second coupling member,
wherein the another edge is electrically connected to the at least one circuit via a third coupling member different from the second coupling member,
wherein a width of the another edge corresponds to a width of the edge, and
wherein the another edge is disposed spaced apart from the edge.

6. The wearable device of claim 1,
wherein the conductive portion is disposed spaced apart from the another conductive portion,
wherein the conductive portion includes:
a first edge, extending along the housing in a first direction from a first portion coupled to the second coupling member,
a second edge, extending along the housing in a second direction perpendicular to the first direction from the first edge, and
a third edge, extending along the housing in a third direction perpendicular to the second direction and opposite to the first direction from the second edge, and
wherein the third edge is coupled to the first coupling member.

7. The wearable device of claim 6,
wherein the conductive portion is disposed spaced apart from the another conductive portion,
wherein the conductive portion further includes:
a fourth edge, extending along the housing in the third direction, extending from the third edge from a portion where the first coupling member and the third edge are coupled,
a fifth edge, extending along the housing in the second direction, extending from the fourth edge, and
a sixth edge, extending along the housing in the first direction, extending from the fifth edge, and
wherein the third edge is disposed spaced apart from the first edge.

8. The wearable device of claim 1,
wherein the conductive portion includes a first portion, a second portion, and a third portion,
wherein the first portion is an edge extending along the housing as the ring-shape from a first point, spaced apart from the another conductive portion, coupled to the second coupling member,
wherein the second portion is an edge extending along the housing as the ring-shape from a second point different from the first point, spaced apart from the another conductive portion, coupled to the second coupling member,
wherein the third portion is spaced apart from each of the first portion and the second portion, and extends along the housing as the ring-shape from a third point different from the first point and the second point, spaced apart from the another conductive portion, coupled to the second coupling member, and
wherein a width of the third portion is wider than a width of the first portion and a width of the second portion, and is narrower than a width of the outer surface.

9. The wearable device of claim 1, wherein the outer surface of the housing is configured as one of a conductive member, a non-conductive member, or a combination of a conductive member and a non-conductive member.

10. The wearable device of claim 1, wherein the inner surface of the housing including another conductive member:
is formed as another ring-shape smaller than the ring-shape of the housing;
includes portions configuring another ring shape of the housing and is formed so that each of the portions is segmented at a specified distance from each other; or
is formed to correspond to a portion of a small ring-shape.

11. The wearable device of claim 1,
wherein the wearable device further comprises a third coupling member different from the first coupling member, and
wherein the third coupling member electrically connects the conductive portion and the another conductive portion at a position different from the first coupling member.

12. The wearable device of claim 1,
wherein the first coupling member includes a coupling structure based on at least one from among a soldering, a coupling, or a connector, and
wherein the second coupling member includes a coupling structure based on a soldering.

13. The wearable device of claim 1,
wherein the first coupling member is configured:
as a variable capacitor or a switch, or
to be capable of changing a position where the conductive portion and another conductive portion are coupled, and
wherein the second coupling member is configured as a variable capacitor or a switch.

14. The wearable device of claim 1,
wherein the wearable device further includes a display, and
wherein the display is formed in a first region of the outer surface corresponding to the conductive portion and a third region of the outer surface different from a second region of the outer surface corresponding to the second coupling member.

15. The wearable device of claim 1,
wherein the wearable device further includes a battery, and
wherein the battery is mounted across the first layer and the second layer.

16. A wearable device comprising:
a housing with a ring-shape including an inner surface and an outer surface;
a layer disposed between the inner surface and the outer surface of the housing, including a printed circuit board (PCB) and a conductive portion;
at least one circuit for wireless communication attached to the PCB;
another conductive portion formed in a portion of the inner surface;
a first coupling member for electrically connecting the PCB and the another conductive portion; and
a second coupling member for electrically connecting the conductive portion and the at least one circuit,
wherein the at least one circuit is configured to communicate with an external electronic device by using the conductive portion obtaining a signal fed from the at least one circuit and the another conductive portion coupled to a ground.

17. The wearable device of claim 16,
wherein the conductive portion extends from a first portion, spaced apart from the another conductive portion, coupled to the second coupling member along the outer surface of the housing as the ring-shape, and
wherein a width of the conductive portion corresponds to a width of the outer surface.

18. The wearable device of claim 16,
wherein the conductive portion includes a first conductive portion and a second conductive portion,
wherein the first conductive portion includes:
a first edge, extending along the housing in a first direction, from a first portion, spaced apart from the another conductive portion, coupled to the second coupling member,
a second edge, extending from the first edge, extending along the housing in a second direction perpendicular to the first direction,
a third edge, extending from the second edge, extending along the housing in a third direction perpendicular to the second direction and opposite to the first direction,
a fourth edge, extending from the third edge, extending along the housing in a fourth direction perpendicular to the third direction and opposite to the second direction, and
a fifth edge, extending from the fourth edge, extending along the housing in the first direction, and coupled to the first coupling member, and wherein the first edge is disposed spaced apart from the fifth edge.

19. The wearable device of claim 16,
wherein the conductive portion includes an edge extending along the housing as the ring-shape from a first portion, spaced apart from the another conductive portion, coupled to the second coupling member, and
wherein a width of the edge is narrower than a width of the outer surface.

20. The wearable device of claim 16,
wherein the conductive portion is disposed spaced apart from the another conductive portion,
wherein the conductive portion includes:
a first edge, extending along the housing in a first direction from a first portion coupled to the second coupling member,
a second edge, extending along the housing in a second direction perpendicular to the first direction from the first edge, and
a third edge, extending along the housing in a third direction perpendicular to the second direction and opposite to the first direction from the second edge, and
wherein the third edge is coupled to the first connecting member.
